(19) United States
(12) Patent Application Publication
(10) Pub. No.: US 2026/0265075 A1
(43) Pub. Date: Sep. 10, 2026

(54) WATER RESTRICTED SYNTHESIS OF ENZYME MIMETIC CERIUM OXIDE AND SILVER CERIUM OXIDE COMPOSITE NANOPARTICLES

(71) Applicant: KISMET TECHNOLOGIES INC., Orlando, FL (US)

(72) Inventor: Christopher Shannon Coughlin, Orlando, FL (US)

(21) Appl. No.: 19/561,242

(22) Filed: Mar. 9, 2026

Related U.S. Application Data
(60) Provisional application No. 63/769,416, filed on Mar. 10, 2025.

(51) Int. Cl. C01F 17/235; C01G 5/00

(52) U.S. Cl. CPC C01F 17/235; C01G 5/006; C01P 2002/84; C01P 2004/64

(57) ABSTRACT

A method for manufacturing cerium oxide nanoparticles (CNPs) is disclosed including ageing in a closed system un-aged cerium oxide nanoparticles in a solution that uses at least one accelerant to speed up peroxy ligand conversion of CNPs and accelerates evolution. The at least one accelerant is selected from a group consisting of ethanol mixed with between 1% and 5% water, low heat of 90°-115°F applied to the closed system to heat the solution only after crash-out of the solution that is without an ingredient that incudes wholly un-stabilized hydrogen peroxide, wholly un-stabilized hydrogen peroxide mixed in the solution prior to aging in the closed system, low heat of 90°-115°F applied to the closed system to heat the solution that includes wholly un-stabilized hydrogen peroxide, and a form factor ratio of a vessel of the closed system where the ageing takes place. A method of manufacturing AgCNPs is also disclosed.

### BACKGROUND

Embodiments relate to large-scale manufacturing processes for organic solvent mediated cerium oxide nanoparticles and silver cerium oxide composite nanoparticles.

The process for manufacturing metal-mediated cerium oxide nanoparticles requires an ageing process to produce bio-active particles. Some processes of ageing metal-mediated cerium oxide include placing a solution with the un-aged cerium oxide nanoparticles in a container and observing a color change in the solution. For example, the solution of the un-aged cerium oxide nanoparticles that is to be aged may have a yellow tint. At the end of an ageing process, the solution becomes clear. An ageing process can use ionized silver during the ageing time to evolve into a metallic silver phase on the ceria surface. However, the ageing process can be very slow and costly.

A prior invention disclosed a novel synthesis to produce a specialized form of Janus-type metal mediated cerium oxide nanoparticles with Ce³⁺ being the predominant species and exhibiting super oxide dismutase (SOD) enzyme like behavior. As a consequence, the solution that may contain some ionized silver is washed to remove the ionized silver. However, the dialysis and washing process adds costs and increases synthesis time. However, this prior art process requires an extended time to age. Thus, the initial synthesis required a long aging time (3-4 months for 50mL) that increased with increasing synthesis volume. Additionally, a lot of water (8L for 50 mL of synthesized solution) was also required, driving up cost and waste.

In another, a co-pending patent application (unpublished at the time of filing this application), though less costly, the aging time is independent of volume or form factor, but the ageing time still took at least several days up to a week.

Each of the prior art references is specific to the aging of metal mediated cerium oxide nanoparticles, where non-limiting examples are shown with respect to silver cerium oxide nanoparticles (AgCNPs). Another non-metallic mediation scheme for cerium oxide nanoparticles to be highly bioactive was not known until now.

Having a process that can decrease the aging time to form nanoparticles of organic solvent mediated cerium oxide nanoparticles (NCPs) and organic solvent mediated silver cerium oxide nanoparticles (AgCNPs) to under 24 hours is desired.

### SUMMARY

Embodiments relate to large-scale manufacturing processes for organic solvent mediated cerium oxide nanoparticles and organic solvent mediated silver cerium oxide nanoparticles to accelerate the aging process with the use of an organic solvent.

A method for manufacturing cerium oxide nanoparticles (CNPs) is disclosed. The method comprises ageing in a closed system un-aged cerium oxide nanoparticles in a solution that uses at least one accelerant, the at least one accelerant speeds up peroxy ligand conversion of cerium oxide nanoparticles (CNPs) and accelerates evolution to 1ppm or less of the limit of detection, cerium oxide nanoparticles (CNPs). The at least one accelerant is selected from the group consists of a solution consisting of ethanol mixed with between 1% and 5% water; low heat of 90°-115° F applied to the closed system to heat the solution only after crash-out of the solution that is without an ingredient that incudes wholly un-stabilized hydrogen peroxide; wholly un-stabilized hydrogen peroxide mixed in the solution prior to aging in the closed system; low heat of 90°-115° F applied to the closed system to heat the solution that includes wholly un-stabilized hydrogen peroxide; and a form factor (FF) ratio of a vessel of the closed system where the ageing takes place.

In another embodiment, a method for manufacturing silver cerium oxide nanoparticles (AgCNPs) is disclosed. The method comprises ageing in a closed system un-aged cerium oxide nanoparticles in a solution that uses at least one accelerant, the at least one accelerant speeds up peroxy ligand conversion of silver cerium oxide nanoparticles (AgCNPs) having a predominant Ce³⁺ oxidation state and accelerates evolution to 1ppm or less of the limit of detection silver cerium oxide nanoparticles (AgCNPs). The at least one accelerant is selected from the group consisting of a solution consisting of ethanol mixed with between 1% and 5% water; low heat of 90°-115° F applied to the closed system to heat the solution only after crash-out of the solution that is without an ingredient that incudes wholly un-stabilized hydrogen peroxide; wholly un-stabilized hydrogen peroxide mixed in the solution prior to aging in the closed system; low heat of 90°-115° F applied to the closed system to heat the solution that includes wholly un-stabilized hydrogen peroxide; and a form factor (FF) ratio of a vessel of the closed system where the ageing takes place.

### BRIEF DESCRIPTION OF THE DRAWINGS

To easily identify the discussion of any particular element or act, the most significant digit or digits in a reference number refer to the figure number in which that element is first introduced as discussed below:

FIG. 1 illustrates a flowchart of a process for making CNP in accordance with one embodiment;

FIG. 2 illustrates a flowchart of a process for making AgCNP in accordance with one embodiment;

FIG. 3 illustrates the aging process of the CNP’s over 8 days after mixing;

FIG. 4 illustrates the UV-Visible spectroscopic characterization of cerium oxide nanoparticles synthesized in ethanol;

FIG. 5 illustrates the Superoxide Dismutase Activity (SOD) characterization of cerium oxide nanoparticles synthesized in ethanol;

FIG. 6 illustrates the Dry Film Efficacy of Cerium oxide nanoparticles against Staphylococcus epidermidis;

FIG. 7A illustrates a vessel in accordance with one embodiment;

FIG. 7B illustrates a first vessel filled with synthesizing solution and precipitates in accordance with one embodiment;

FIG. 7C illustrates a second vessel filled with synthesizing solution and particulates in accordance with one embodiment;

FIG. 8 illustrates a system for the peroxy ligand conversion to silver-mediated cerium oxide nanoparticles according to one embodiment;

FIG. 9A illustrates a first closed system in accordance with one embodiment;

FIG. 9B illustrates an aspect of the subject matter in accordance with one embodiment;

FIG. 10A illustrates a cross-sectional view of a touch screen in accordance with one embodiment;

FIG. 10B illustrates an aspect of the subject matter in accordance with one embodiment;

FIG. 11 illustrates a flowchart of a method for forming a touch screen display in accordance with one embodiment;

FIG. 12 illustrates a wound care article according to an embodiment;

FIG. 13 illustrates a wound care article according to an embodiment;

FIG. 14 illustrates a wound care article according to an embodiment;

FIG. 15 illustrates a wound healing article according to an embodiment;

FIG. 16 illustrates a wound healing article according to an embodiment;

FIG. 17 illustrates a wound healing article having a body with a three-ply structure according to an embodiment;

FIG. 18 illustrates a wound healing article having body with a two-ply structure according to an embodiment;

FIG. 19 illustrates a side view of a wound healing article with a face mask form factor according to an embodiment;

FIG. 20 illustrates a surface of an article coated with a coating composition in accordance with one embodiment;

FIG. 21A illustrates a toilet seat coated with a coating composition in accordance with one embodiment;

FIG. 21B illustrates a door with a door handle coated with a coating composition in accordance with one embodiment;

FIG. 22A illustrates furniture coated with a coating composition in accordance with one embodiment;

FIG. 22B illustrates fabric coated with a coating composition in accordance with one embodiment;

FIG. 22C illustrates an interior wall of a building coated with a coating composition and having a door and a window in accordance with one embodiment;

FIG. 23 illustrates a flowchart of a process for coating a surface in accordance with one embodiment;

FIG. 24A illustrates a subject tooth 2800 in a clean state;

FIG. 24B illustrates a subject tooth of FIG. 23A with a coating of dental resin composite including CNPs coated on the tooth in accordance with one embodiment;

FIG. 25 illustrates a coated subject tooth of FIG. 23B in the mouth with bacteria;

FIG. 26 illustrates a coated subject tooth of FIG. 24 releasing directed hydrogen peroxide (H₂O₂) to degrade or destroy caries-causing bacteria in accordance with one embodiment;

FIG. 27 illustrates the coated subject tooth of FIG. 25 with the bacteria degraded or destroyed.

### DETAILED DESCRIPTION

Embodiments disclosed herein provide for an improved process for large scale synthesis of organic solvent mediated cerium oxide nanoparticles, and organic solvent mediated silver cerium oxide nanoparticles are presented. Major changes to prior art processes include use of an organic solvent with a restriction in the water content during synthesis of Janus-type silver cerium oxide nanoparticles. However, synthesis of organic solvent mediated cerium oxide nanoparticles and organic solvent mediated metal silver cerium oxide nanoparticles was not known where synthesis can occur in less than 24 hours. Inclusion of an organic solvent reduces the aging time of organic solvent mediated cerium oxide nanoparticles and organic solvent mediated silver cerium oxide nanoparticles to less than 24 hours. Thus, embodiments disclosed herein drastically decrease the aging time and cost for creation of organic solvent mediated cerium oxide nanoparticles and organic solvent mediated silver cerium oxide nanoparticles with Ce³⁺ being the predominant species with super oxide dismutase (SOD) enzyme like behavior.

The inventors have surprisingly determined that organic solvent mediated cerium oxide nanoparticles (CNPs) and organic solvent mediated silver cerium oxide nanoparticles (AgCNP) with Ce³⁺ being the predominant oxidation state, as described herein, can be manufactured using a process including an ethanol, water, and hydrogen peroxide solution that speeds up the peroxy ligand conversion to nanoparticles. The accelerant aids in improved aging time of CNPs and AgCNPs.

The inventors have surprisingly determined that the ethanol mediated cerium oxide nanoparticles (CNPs) and organic solvent mediated silver cerium oxide nanoparticles (AgCNPs), as described herein, can be manufactured using a process including an ethanol based water restricted solution that speeds up the peroxy ligand conversion to nanoparticles. At least one accelerant evolves the CNPs and AgCNPs to a crystalline phase more rapidly than currently possible using a low temperature aging method.

The inventors have surprisingly determined that CNPs and AgCNPs, as described herein, can be manufactured using a process including an ethanol and restricted water solution that speeds up the peroxy ligand conversion to nanoparticles by using low heat and specifically below the boiling point of water or other processing aqueous solution, for example.

The inventors have surprisingly determined that CNPs and AgCNPs, as described herein, can be manufactured using a process including a water restricted ethanol solution that speeds up the peroxy ligand conversion to nanoparticles by using a vessel form factor with or without heat, the form factor that limits stacking and/or crowding of the crashed-out particulates to maximize the particulates’ surface being in direct contact with the water or other processing aqueous solution.

The inventors have surprisingly determined that CNPs and AgCNPs, as described herein, can be manufactured using a process in a closed system including an ethanol based solution that produces CNPs and AgCNPs in a single vessel without the need for removal from or repackaging of the final product of a colloidal solution of CNPs and AgCNPs from the closed system.

The inventors have surprisingly determined that CNPs and AgCNPs, as described herein, can be manufactured using a process including an ethanol based solution that produces CNPs where aging is performed at low heat of 90-115 °F (or 32.2-46°C) to speed up the ageing process.

The inventors have surprisingly determined that organic solvent mediated cerium oxide nanoparticles (CNPs) and organic solvent mediated silver cerium oxide nanoparticles (AgCNPs), as described herein, can be manufactured using the process that uses low heat of 90-115 °F (or 32.2-46°C) over the aging period to speed up the ageing process by a factor of more than 84x for a 50 mL solution.

The inventors have surprisingly determined that CNPs and AgCNPs, as described herein, can be manufactured using the process to rapidly crystallize cerium oxide nanoparticles and silver cerium oxide nanoparticles for a solution forming the CNPs and AgCNPs without the need to wash the residual particles.

The inventors have surprisingly determined that CNPs and AgCNPs can be manufactured using a shortened process that does not require washing of residual particles and has the ability to shorten the manufacturing time to colloidal stability of the solution reduces the storage facility and climate control necessary to store the colloidal solution as it is being produced.

The inventors have surprisingly determined that the aging time for creation of at least one of organic solvent mediated cerium oxide nanoparticles and organic solvent mediated silver cerium oxide nanoparticles with Ce³⁺ being the predominant species and having super oxide dismutase (SOD) enzyme like behavior can be improved to under 8 hours with the use of a water restricted ethanol solution during the synthesis process.

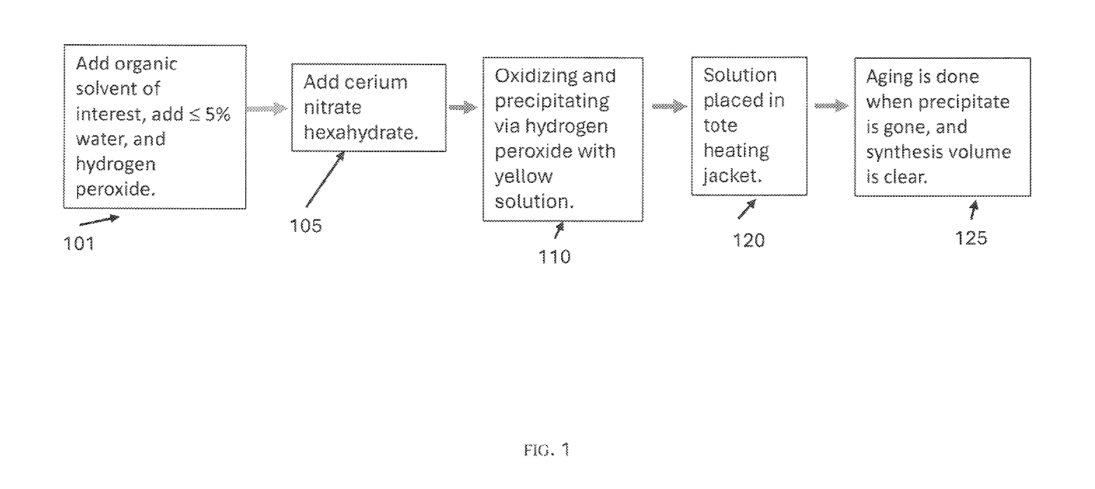

FIG. 1 illustrates a flowchart of a process for making CNPs in accordance with an embodiment disclosed herein. Cerium oxide nanoparticles typically precipitate quickly and then redissolve over the course of 8 hours to yield a substantially clear dispersion with a limited amount of precipitate. An amount of water is typically less than 1% but may be up to 5% and is selected to maintain a molar ratio of water to cerium of at least 12. Thus, the process includes an amount of water that is typically less than 1% but may be up to 5% and is selected to maintain a molar ratio of water to cerium of at least 12. Thus, in general, as shown, a process may begin with adding an organic solvent of interest along with water, as described above, and hydrogen peroxide, at 101. Cerium nitrate hexahydrate is then added, at 105. Oxidizing and precipitatin via hydrogen pereoxide with yellow solution, at 110. The solution is placed in a tote heating jacket, at 115. Aging is done when the precipitate is gone, resulting in a synthesis volume that is clear, at 120.

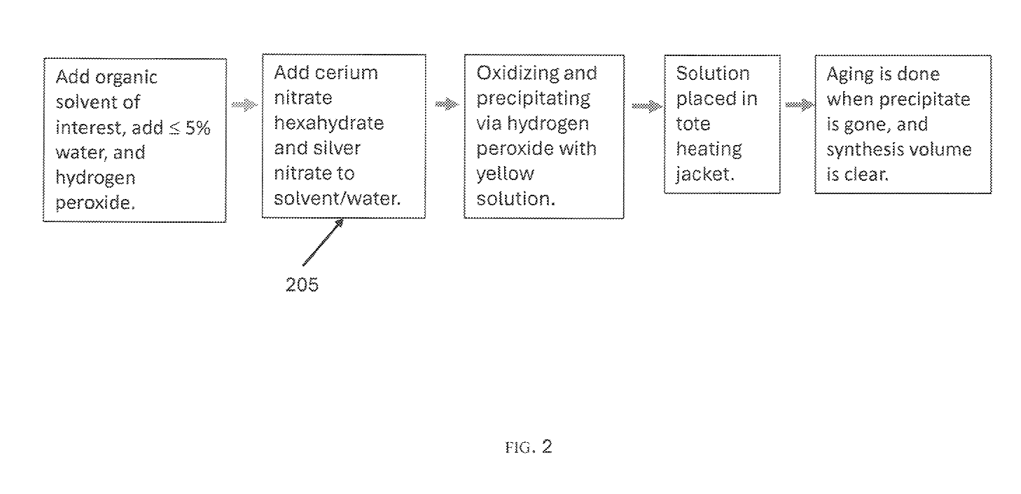

FIG. 2 illustrates a flowchart of a process for making AgCNPs in accordance with an embodiment disclosed herein. The process includes an amount of water that is typically less than 1% but may be up to 5% and is selected to maintain a molar ratio of water to cerium of at least 12. Thus in general, as shown, a process may begin with adding an organic solvent of interest along with water, as described above, and hydrogen peroxide. Here, silver nitrate is also added to the solvent/water when adding cerium nitrate hexahydrate, at 205

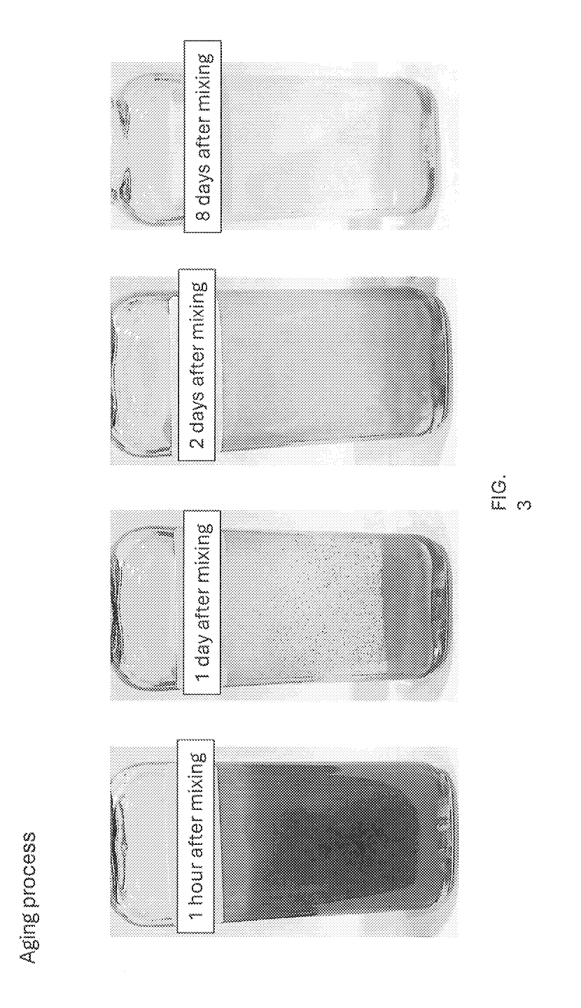

FIG. 3 illustrates the aging process of the CNPs and AgCNPs. The next step is adding cerium nitrate hexahydrate to the ethanol, water, and hydrogen peroxide mixture to create a solution. The next step involves oxidizing and precipitating via hydrogen peroxide with yellow solution. The next step provides for heating the resulting solution. As a non-limiting example, heating may occur by placing the resulting solution in a tote heating jacket. The next step provides for aging the resulting solution. Aging is done or complete when precipitate is gone, and synthesis volume is clear.

Non-limiting examples of the organic solvent include, but are not limited to, ethanol. Thus, it is evident that an organic solvent may be used. Typically, organic solvents are added in the synthesis of cerium oxide nanoparticles to control the particle size, morphology, aggregation, agglomeration, and lattice structure. Additionally, many syntheses in prior art literature use organic solvents in amounts between 20 and 30 % by volume. The inventors have determined that the organic solvents behave as a catalyst that speeds the aging process of cerium oxide at low temperatures (<50 ^{o}C) and in a range of 95 to 99% by volume.

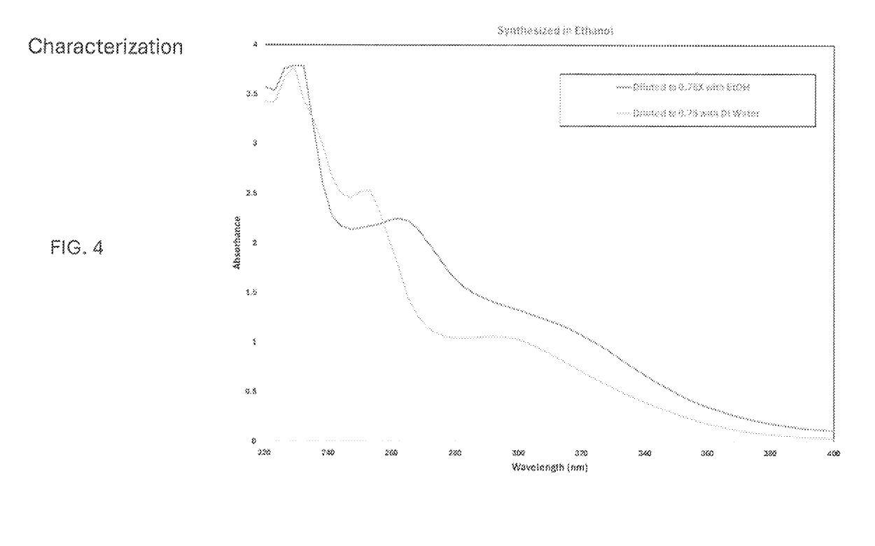

FIG. 4 shows the UV-Visible spectroscopic characterization of cerium oxide nanoparticles synthesized in ethanol. The spectrum as obtained in ethanol shows shifts in the characteristic ceria peaks at 254 and 300 nm, but dilution with water shows the peaks shifting back into the expected position indicating that the expected cerium oxide was successfully synthesized in ethanol with minimal water.

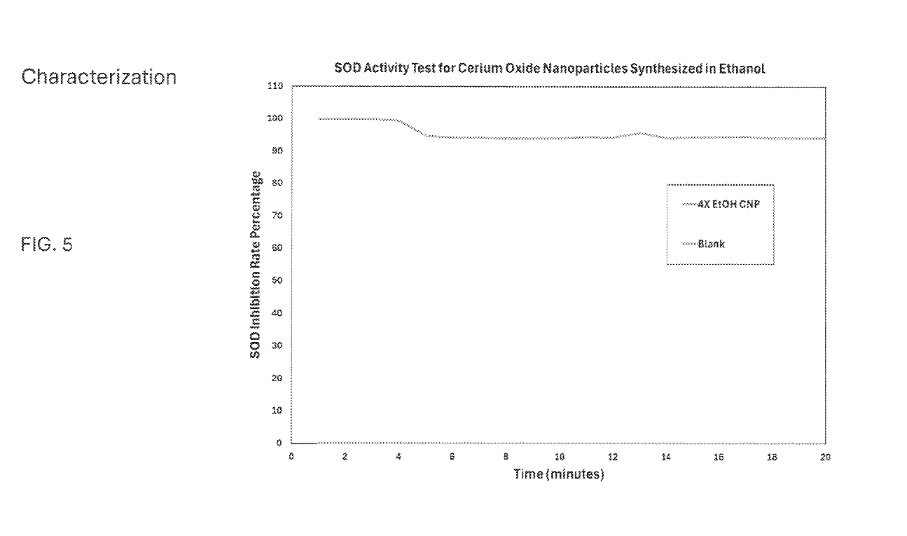

FIG. 5 shows a graph of Superoxide Dismutase Activity (SOD) characterization of cerium oxide nanoparticles synthesized in ethanol. Ongoing SOD activity is demonstrated by the very high SOD Inhibition Rate percentage (>94%) over the course of 20 minutes in the presence of nanoparticles. This indicates that the enzyme mimetic nature of the cerium oxide was successfully reproduced when synthesized in ethanol with minimal water.

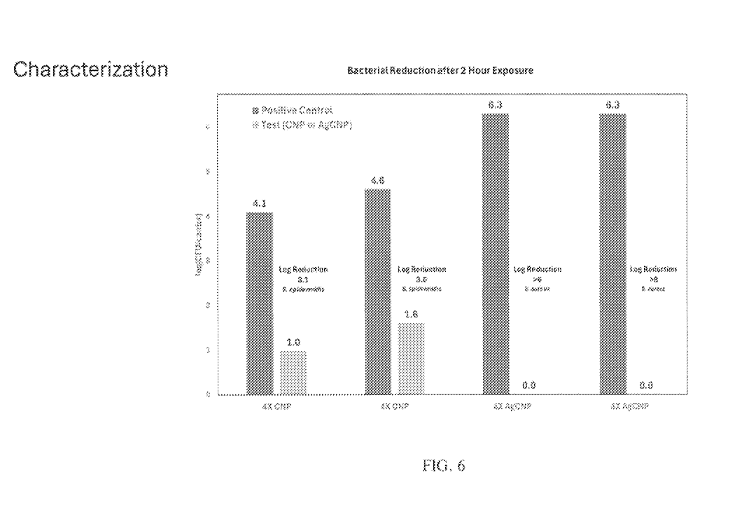

FIG. 6 shows Dry Film Efficacy of Cerium oxide nanoparticles and silver cerium oxide nanoparticles against Staphylococcus epidermidis. Cerium oxide nanoparticles showed a 3-log reduction and silver cerium oxide nanoparticles showed a 6-log reduction in surviving bacteria indicating that the expected cerium oxide with ROS functionality was successfully synthesized in ethanol with minimal water.

Unless specifically stated or obvious from context, as used herein, the term "about" is understood as within a range of normal tolerance in the art, for example, within 2 standard deviations of the mean. “About” can be understood as within 30%, 25%, 20%, 15%, 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

As used herein, the term “composition” or “composite” as used herein refers to a product that includes ingredients such as one or more of chemical elements, diluent, binder, additive, or constituent in specified amounts, in addition to any product which results, whether directly or indirectly, from a combination of the ingredients in the specified amounts.

The term “prevention” or “preventing” of a disorder, disease, or condition as used herein refers to, in a statistical sample, a measurable or observable reduction in the occurrence of the disorder, disease or condition in the treated sample set being treated relative to an untreated control sample set, or delays the onset of one or more symptoms of the disorder, disease or condition relative to the untreated control sample set.

As used herein, the term “subject,” “individual” or “patient” refers to a human, a mammal, or an animal.

The term “therapeutically effective amount” as used herein refers to an amount of active compound or pharmaceutical agent that elicits the biological or medicinal response in a tissue, system, animal, or human that is being sought by a researcher, veterinarian, medical doctor, or other clinician. A therapeutically effective amount can be given in one or more administrations. The amount of a compound which constitutes a therapeutically effective amount will vary depending on the compound, the disorder and its severity, and the general health, age, sex, body weight and tolerance to drugs of the subject to be treated, but can be determined routinely by one of ordinary skill in the art.

The term “treating” or “treatment” as used herein covers the treatment of a disorder, disease or condition described herein, in a subject, and includes: (i) inhibiting development of a disorder, disease or condition; (ii) slowing progression of the disorder, disease or condition; (iii) inhibiting, relieving, or slowing progression of one or more symptoms of the disorder, disease or condition; and (iv) assisting with a body’s naturally occurring processes to remineralize tooth material to further strengthen teeth against decay and sensitivity.

The term “cerium oxide nanoparticles,” or “CNPs” and “silver cerium oxide nanoparticles” or “AgCNPs” as used herein refers to cerium oxide nanoparticles and silver cerium oxide nanoparticles with Ce³⁺ being the predominant species where aging is accelerated with the use of a organic solvent solution. In an embodiment, the cerium oxide nanoparticles with predominantly Ce³⁺ oxidation state comprise a particle size in the range of 3 nm – 35 nm, with a preferred range from 10 nm - 20 nm.

The CNPs and AgCNPs, as described herein, is a NanoRAD ingredient.

The term “predominant Ce³⁺”means that Ce³⁺ makes up more than 50% of the composition.

The term “predominant Ce³⁺” means that the [Ce³⁺]:[Ce⁴⁺] ratio of oxidation states of the cerium oxide nanoparticle or portion of the nanoparticle composed of cerium oxide is greater than 50%. In a specific example, the [Ce³⁺]:[Ce⁴⁺] ratio is greater than 60%.

The term “crash-out” as used herein refers to a process where something precipitates out of solution and collects at the bottom of the solution.

Cerium oxide nanoparticles and silver cerium oxide nanoparticles have a variety of applications from the treatment of epithelial tissue for wound healing, dental caries, ocular wounds, treatment of surfaces as a disinfectant, preparation of coatings for objects with high touch exposure and more.

The inventors have determined that the initial (original) synthesis requires a long ageing time that increased with increasing synthesis volume. Additionally, the initial synthesis required a water intensive washing step at the end of the ageing period that required a considerable amount of water (8L for 50 mL of synthesized solution) that must then be treated as hazardous waste post synthesis. The new synthesis eliminates washing of the CNPs and AgCNPs.

The embodiments described herein provide a new synthesis process that reduces the time and cost to produce these nanoparticles (i.e., CNPs, AgCNPs) with predominantly Ce³⁺ in bulk. The new synthesis process provides 1) an increase in concentration of reactants per unit volume, and 2) elimination of the end washing step using at least one of a heating step to decrease the ageing time, a vessel form factor for decreasing ageing time, and wholly un-stabilized hydrogen peroxide, 3) significant reduction in the ageing time of the batch under eight (8) hours.

These improvements of the new synthesis drastically decrease the ageing time and cost for creation of cerium oxide nanoparticles and silver cerium oxide nanoparticles with Ce³⁺ being the predominant oxidation state and super oxide dismutase (SOD) enzyme mimetic behavior.

This new synthesis allows for large scale production of cerium oxide nanoparticle and silver cerium oxide nanoparticle colloid in a reduced amount of time.

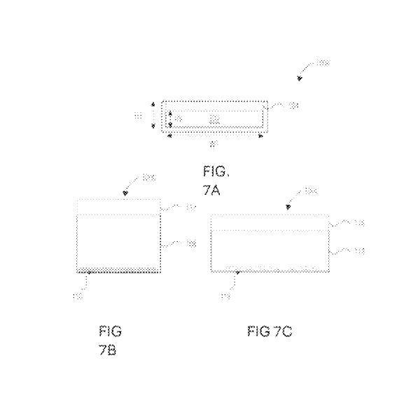

FIG. 7A illustrates a vessel 100a in accordance with one embodiment. The vessel 100a houses an ethanol, hydrogen peroxide, and water solution (hereinafter described as a water restricted mixture), as disclosed herein. The water restricted solution aids in evolution of CNPs and AgCNPs, The vessel 100a with a surface area to synthesis volume form factor that increases the area of nanoparticles able to access water (or restricted water mixture) to undergo crystallization to a colloid and resuspend into the solution.

The vessel 100a has an interior surface (IS) height H1 and an interior surface (IS) width W1. If the vessel 100 is round, the IS width W1 may be an inner diameter (ID). The vessel 100a has an IS height H1 that is smaller than the IS width W1 such that form factor (FF) ratio W1/ H1 > 1. H1 describes the height on the volume of synthesis fluid in the container. For example, for the same vessel type, with a fixed height and diameter, decreasing the total reaction volume to a height in the vessel that achieves a ration of W1/H1 > 1.

By way of non-limiting example, the vessel 100a may have an IS height H1 and IS width W1 which are equal. However, the height of the volume HV of solution should be less than IS width W1 so that the FF ratio is W1/HV > 1.

By way of non-limiting example, the vessel 100a may have an IS height H1 that is larger than the IS width W1. However, the height of the volume HV of solution should be less than IS width W1 so that the FF ratio is W1/HV > 1. This can be achieved by using about a third of the available height in the vessel, by example, so that the vessel becomes an accelerant.

In one example, the vessel is selected such that the FF ratio W1/HV is in the range of 0.20-0.50.

FIG. 7B illustrates a first vessel 100b filled with the aqueous polymer solution and combined with a synthesizing solution and precipitates in accordance with one embodiment. FIG. 7C illustrates a second vessel 100c filled with the aqueous polymer solution and combined with the synthesizing solution and precipitates in accordance with one embodiment.

FIG. 7B illustrates a first vessel 100b with a width/height < 1. The first vessel 100b has an internal volume 112 with portion 108 filled with a synthesizing solution and crashed-out precipitates 110 collecting in the bottom of the internal volume 112. The width compared to the volume of the synthesizing solution causes stacking and crowding of the precipitates 110 which causes the surface-to-surface contact of adjacent and surrounding precipitates, reducing particulate access to water. The points of the precipitate’s surface that are in direct surface-to-surface contact with other precipitates do not have immediate and/or direct access to the synthesizing solution. The inventors have determined that crowding of the precipitates 110 increases the ageing time because portions of the surface of particulates have limited access to the synthesizing solution, which delays the peroxy ligand conversion to organic solvent mediated cerium oxide nanoparticles and organic solvent mediated silver cerium oxide nanoparticles as colloids in solution.

FIG. 7C illustrates the second vessel 100c with a width/height >1 to increase the concentration of reactants per unit volume for access by the precipitates. In FIG. 7C, the second vessel 100c has an internal volume 116 with portion 114 filled with a synthesizing solution and crashed-out precipitates 118 collecting in the bottom of the internal volume 116. The precipitates 118 are shown less crowded. Therefore, less portions of the surface of the precipitates 118 are in direct surface-to-surface contact with surrounding precipitates. As a consequence, the surface of the precipitates 118 compared to surface of precipitates 110 have an increase in access to the concentration of reactants per unit volume.

The form factor may be an important consideration especially for the manufacture of large volumes of organic solvent mediated cerium oxide nanoparticles and organic solvent mediated silver cerium oxide nanoparticles, especially if a single vessel is used.

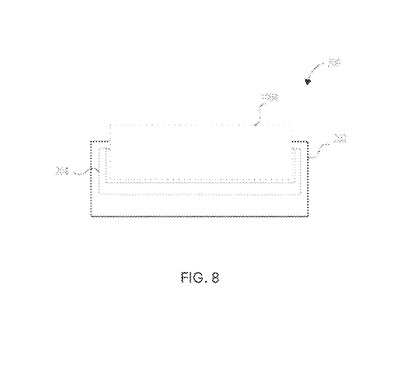

FIG. 8 illustrates a system 200 for the peroxy ligand conversion to organic solvent mediated cerium oxide nanoparticles and organic solvent mediated silver cerium oxide nanoparticles according to one embodiment. The system 200 may include vessel 100a and heating device 202. The bottom surface of vessel 100a may be in direct contact with the heating surface 204 of the heating device 202. The heat from the heating device 202 may be an accelerant to shorten the time for the peroxy ligand conversion to organic solvent mediated cerium oxide nanoparticles and organic solvent mediated silver cerium oxide nanoparticles.

Both heating and the form factor of the vessel provide two accelerants to shorten the time for the peroxy ligand conversion to organic solvent mediated cerium oxide nanoparticles and organic solvent mediated silver cerium oxide nanoparticles. The low heat applied to the vessel 100a allows ageing to take place in a shorter time period as compared to other processes. In an embodiment that uses non-wholly un-stabilized hydrogen peroxide

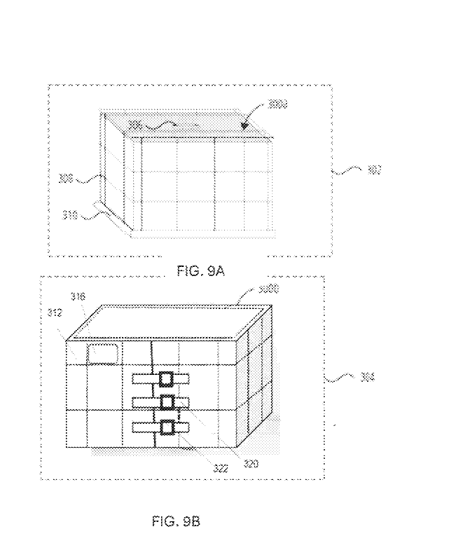

FIG. 9A illustrates a first closed system 302 in accordance with one embodiment. The first closed system 302 includes a vessel 300a. The methods for manufacturing CNPs and AgCNPs with a predominant Ce³⁺ oxidation state is configured for closed system processing. A closed system minimizes introduction of contaminates since a single closed system vessel can be used throughout the manufacturing process to produce a volume of a colloidal composition of the manufactured CNPs and AgCNPs with a predominant Ce³⁺ oxidation state. The new synthesis eliminates the need to wash or any other post processing steps.

In some embodiments, a colloidal composition of the manufactured CNPs and AgCNPs with a predominant Ce³⁺ oxidation state can be manufactured in a vessel that is for example 250+ gallons and subsequently, sold and distributed (transported) using the same closed system vessel. The vessel may be approved for food grade applications meeting the Food and Drug Administration (FDA) regulations. The vessel 300a may be made of polyethylene to hold a volume of fluid. The vessel 300a may be supported by a cage 308 and pallet 310 made of steel, aluminum, or other metal. The vessel may include an inlet 306, such as on top of the vessel, and an outlet (not shown).

An example vessel is an IBC tank with steel pallet, sold by ULINE, 12575 Uline Drive, Pleasant Prairie, WI, 53158. Another example vessel includes a 275 Gallon Rebottled IBC Tote that is sold by The Tank Depot, 658 John B Sias Memorial Parkway, Ste 330, Fort Worth, TX, 76134. Vessels of other sizes may be used that are smaller or larger than those described herein.

FIG. 9B illustrates a second closed system 304 in accordance with one embodiment. The second closed system 304 may include a vessel 300b, shown in dashed lines. The vessel 300b may be made of polyethylene configured to house a volume of a fluid or solution for the manufacture of CNPs and AgCNPs with a predominant Ce³⁺ oxidation state. The vessel 300b may be supported by a cage 312, shown in dashed line, which may be made of steel, aluminum, or other metal. The vessel 300b may include an inlet, such as on top of the vessel, and an outlet (not shown). The cage and pallet may be designed to allow for stacking vertically, in some examples, of the vessel 300b.

The second closed system 304 may also include a heating device 316. The heating device 316 may include an IBC tote heater configured to wrap around vertical side of the cage and vessel. The IBC tote heater may be sold by The Tank Depot, 658 John B Sias Memorial Parkway, Ste 330, Fort Worth, TX, 76134. Another example is Global Industrial® Insulated Tote Heating Blanket For 275 Gal IBC Tote, Up To 145°F, 120V. The heating device 316 may include a heating jacket that wraps around the vessel 300b and includes straps 320 with fasteners 322. The heating device may include a control panel to control the heating temperature supplied by the heating device 316.

In some methods described herein below, the heating device 316 is applied after the precipitates crash-out of solution to the bottom of the synthesis volume. In one embodiment, the heat may be applied essentially immediately after all of the ingredients are added to the vessel to make the amount of solution.

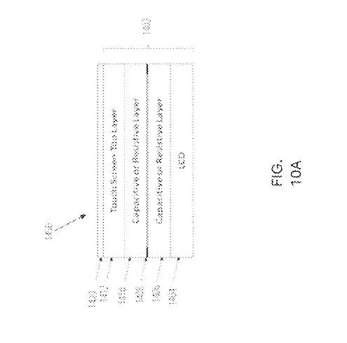

FIG. 10A illustrates a cross-sectional view of a touch screen 1450 in accordance with one embodiment. The touch screen 1450 may include a liquid crystal display (LCD) layer 1404. The LCD layer 1404 may include a liquid crystal cells sub-layer, for example. The LCD layer 1404 may include other sub-layers such as, without limitation, a plurality of sub-layers that include a fluorescent panel, polarization filter(s) and/or color filters (red, green, blue).

The touch screen 1450 may include a touch screen layer stack 1402 with one or more capacitive or resistive layers 1406 and 1410 above the LCD layer 1404, for example. The layer 1404 may include a plurality of layers. In this example, between layer 1406 and layer 1410, electrode layer 1408 may be provided. The capacitive or resistive layer(s) 1406, 1410 may include transparent conductive oxide (TCO) material made from ITO, ATO, or a conductive clear polymer. An example, touch screen is described in U.S. Patent No. 8,400,408, titled “TOUCH SCREENS WITH TRANSPARENT CONDUCTIVE MATERIAL RESISTORS,” assigned to Apple Inc., which is incorporated herein by reference in entirety.

The transparent conductive oxide material is made from indium zinc oxide (IZO) or similar other transparent conductive oxides.

The touch screen layer stack 1402 may include a top layer 1412 on top of the one or more capacitive or resistive layers 1406 and 1410. In this example, the touch screen 1450 includes capacitive or resistive layer 1406 above the LCD layer 1404, electrode layer 1408 followed by a capacitive or resistive layer 1410. The touch screen layer stack 1402 includes a touch screen top layer 1412 above the capacitive or resistive layer 1410. Although the touch screen layer stack 1402 includes an LCD layer 1404, the LCD layer 1404 may be substituted with an LED layer that incorporates types of light-emitting diode technology or LCoS technology. For example, the LCD layer 1404 may be substituted with organic light-emitting elements.

Each layer of the touch screen may include sub-layers. Furthermore, the touch screen 1450 may include other layers not described herein based on the touch screen design.

The touch screen top layer 1412 may be a protective cover such that the capacitive or resistive layer(s) 1406 and 1410 are sandwiched between the top layer 1412 and the lower LCD layer 1404. The top layer 1412 may be made of glass or other transparent protective polymer.

Touch screen 1450 may include mutual-capacitive touch panels formed from rows and columns of traces on opposite sides of a dielectric. At the “intersections” of the traces, where the traces pass above and below each other (but do not make direct electrical contact with each other), the traces essentially form two electrodes with a mutual capacitance therebetween.

The touch screen 1450 may include a nanoparticle coating 1420, denoted with dotted hatching, having a coating composition of CNP or AgCNP having a predominantly Ce³⁺ oxidation state and a binder suitable for glass and which maintains transparency. The coating 1450 having the CNP or AgCNP (CNP and AgCNP as taught in this application) may be bonded to the external side of the top layer 1452, where the CNP or AgCNP may be combined with a binder configured to cause nanoparticles to adhere to a glass surface or glass ceramic surface, such as a top layer of a touch screen surface, to coat the glass surface. The coating may have a thickness in the range of 0.55 to 1.8 millimeters (mm).

A non-limiting example of a binder is described in U.S. Patent No. 10,155,361, titled “METHOD OF BINDING NANOPARTICLES TO GLASS,” assigned to Corning Incorporated, which is incorporated herein by reference in entirety.

The coating composition may include a dispersant additive to assist with CNP or AgCNP mixing. An example dispersant additive may include DISPERBYK-2081, manufactured by BYK-Chemie GmbH, Germany, or a solution of polycarboxylic acid salt. An example dispersant additive includes DISPERBYK-2019, manufactured by BYK-Chemie GmbH, Germany, or a solution of a copolymer with pigment-affinic groups. Recommended levels of the DISPERBYK-2019 additive is 20-60% for transparent iron oxides; 5-40% for inorganic pigments; and 6-8% for titanium dioxide. An example dispersant additive includes BORCHI Gen 1750, manufactured by Borchers, or high molecular weight, volatile organic compound (VOC) free wetting and dispersing agent. Recommended levels of the BORCHI Gen 1750 additive is 50-70% in a mixture including transparent iron oxide; 4-8% in a mixture including titanium dioxide. An example dispersant additive includes BORCHI Gen 12, manufactured by Borchers or low molecular weight non-ionic, alkyl phenol ethoxylates (APEO)- and VOC-free dispersant. Recommended levels of the BORCHI Gen 12 additive is 1-3% in an (oxide) based mixture including titanium dioxide.

The touch screen 1450 may include a support element such as glass, glass ceramic, or the like, a binder and a nanoparticulate layer of CNPs to provide a nanotextured glass surface that has high durability and is ion exchangeable to impart mechanical strength as well as self-disinfecting properties.

The binder may include an alkali silicate, borate, or phosphate. In some embodiments, alkali silicate comprises SiO₂ and Alk₂O, wherein Alk comprises Li, Na or K at a ratio from about 0.05:1 to about 20.0:1 SiO₂:Alk₂O.

In some embodiments, alkali borate comprises R(HnAlk₂O).B₂O₃, n=0 to <2, wherein R is about 0.05 to about 20.0 and Alk comprises Li, Na or K at a ratio from about 0.05:1 to about 20.0:1 SiO₂:R(HnAlk₂O).B₂O₃.

In some embodiments, the binder comprises SiO₂ and HnAlk₃-nPO₄, wherein n=0 to <3 and Alk comprises Li, Na, or K, at a ratio from about 0.05:1 to about 20.0:1 SiO₂:HnAlk₃-nPO₄.

In some embodiments, the binder comprises SiO₂ at a weight percent from about 0.1 to about 40.0.

In some embodiments, the binder is heat-treated to remove water and to form a glass layer or coating.

The binder may be applied by dip coating, spin coating, slot coating, sputtering, DC magnetron sputtering, and various deposition processes. The deposition processes may include vapor deposition, chemical deposition, spray deposition, direct nanoparticle deposition, etc.

In some embodiments, the thickness of the binder comprises less than about one-quarter average diameter or one-half average diameter or the average diameter of said nanoparticles.

The binder may be a binder commonly used to incorporate nanoparticles into indium tin oxide (ITO) such as polyvinylpyrrolidone (PVP). The dispersant additive or binder themselves may be able to achieve good mixing and homogeneity separately or together but is based on the specific manufacturing technique.

Referring now to FIG. 10B, an electronic device 1400 or machine is provided that includes electronic circuitry 1460; and a touch screen user interface (e.g., touch screen display 1450) interfaced with the electronic circuitry, the touch screen user interface includes a top surface layer coated with a coating composition comprising cerium oxide nanoparticles (CNPs) and silver cerium oxide nanoparticles (AgCNPs) as produced by methods disclosed herein having a predominantly Ce³⁺ oxidation state and in a range of about 3-35 nm in size and in an amount that is in a range of 1 weight percentage of a mixture having a binder and the CNPs and AgCNPs.

In view of the foregoing, the embodiments herein are directed to an electronic device with electronic circuitry and a touch-sensitive user interface including a touch screen having a top surface layer and a coating including a coating composition that includes cerium oxide nanoparticles (CNPs) and silver cerium oxide nanoparticles (AgCNPs) as produced by methods disclosed herein having a predominantly Ce³⁺ oxidation state and, as described herein, bonded to the top surface layer, the CNPs or AgCNPs being in the range of 3 nm to 35 nm.

In some embodiments, the touch screen may be integrated with stack layers of a liquid crystal display (LCD) or a light emitting diode (LED) display. The display may be an organic light-emitting diode (OLED) display, a quantum dot display (QLED, or a liquid crystal on silicon (LCoS) display.

In some embodiments, a touch screen display device is provided having a self-disinfecting top surface layer comprising a glass coated surface coated with a coating composition comprising cerium oxide nanoparticles (CNPs) and silver cerium oxide nanoparticles (AgCNPs) as produced by methods disclosed herein having a predominantly Ce³⁺ oxidation state and in a size range of about 3-35 nm and in an amount that is in a range of 1 weight percentage of a mixture having a binder and the CNPs or AgCNPs.

In some embodiments, the binder may be applied to the glass surface to coat the surface by dip coating, spin coating, slot coating, sputtering, DC magnetron sputtering, or various deposition processes. The deposition processes may include vapor deposition, chemical deposition, spray deposition and direct nanoparticle deposition.

In some embodiments, the cerium oxide nanoparticles comprises CNPs in an amount of about 1% by weight in the coating composition. The amount may be 0.05 – 0.99 weight %.

In some embodiments, the silver cerium oxide nanoparticles comprises AgCNPs in an amount of about 1% by weight in the coating composition. The amount may be 0.05 – 0.99 weight %.

The cerium oxide nanoparticles of the coating composition may comprise a predominantly Ce³⁺ oxidation state.

The silver cerium oxide nanoparticles of the coating composition may comprise a predominantly Ce³⁺ oxidation state.

Moreover, the method may include forming a coating for a top surface layer of a touch screen, and/or a coating composition including the CNPs or AgCNPs in an amount of about 1% by weight in the coating composition where the CNPs in the composition are in the range of about 3-35 nm in size. The amount may be about 0.05 - 0.99 weight %.

In some embodiments, the CNPs or AgCNPs of the coating composition for bonding to a touch screen is produced via a method comprising dissolving cerium salts and oxidizing the dissolved cerium precursor salts.

In some embodiments, the CNPs or AgCNPs of the coating composition for bonding to a touch screen may be produced via a method comprising dissolving cerium precursor salts; oxidizing the dissolved cerium precursor salts and silver precursor via admixture with peroxide; and precipitating nanoparticles by subjecting the admixture with ammonium hydroxide.

In some embodiments, a method of disinfecting a touch screen surface includes coating the touch screen surface with a self-disinfecting nanoparticle coating composition including cerium oxide nanoparticles (CNPs) or silver cerium oxide nanoparticles (AgCNPs), as described herein, and a binder where the CNPs or AgCNPs in the coating composition are in the range of about 3-35 nm in size and about 1 weight percentage.

A touch screen display including a touch screen layer stack having a plurality of layers that includes a top surface layer; and a touch screen coating composition coating the top surface layer, the touch screen coating composition comprising cerium oxide nanoparticles (CNP) or silver cerium oxide nanoparticles (AgCNPs) as taught herein having a predominantly Ce³⁺ oxidation state and in a range of about 3-35 nm in size and in an amount that is in a range of about 1 weight percentage of a mixture having a binder and the CNPs or AgCNPs..

The touch screen layer stack includes one of a liquid crystal display (LCD), a light emitting diode (LED) display, an organic light-emitting diode (OLED) display, a quantum dot display (QLED), and a liquid crystal on silicon (LCoS) display.

The binder includes one of alkali silicate, borate, phosphate and polyvinyl pyrrolidone.

The binder includes alkali silicate that comprises SiO₂ and Alk₂O, wherein Alk comprises Li, Na or K at a ratio from about 0.05:1 to about 20.0:1 SiO₂:Alk₂O.

The touch screen layer stack includes resistive or capacitive elements below the top surface layer, the resistive or capacitive elements are made of one of indium tin oxide (ITO) and antimony tin oxide (ATO).

The coating composition is self-disinfecting surface that is optically transparent.

The coating composition further includes a dispersant additive including a copolymer with oxide-affinic groups or polymer non-ionic dispersing additive, and the binder includes polyvinylpyrrolidone.

An electronic device includes electronic circuitry; and the touch screen display having a touch screen coating composition as described herein and, interfaced with the electronic circuitry.

The touch screen display comprises one of a liquid crystal display (LCD), a light emitting diode (LED) display, an organic light-emitting diode (OLED) display, a quantum dot display (QLED) and a liquid crystal on silicon (LCoS) display.

The binder includes one of alkali silicate, borate, phosphate and polyvinyl pyrrolidone.

The binder includes alkali silicate that comprises SiO₂ and Alk₂O, wherein Alk comprises Li, Na or K at a ratio from about 0.05:1 to about 20.0:1 SiO₂:Alk₂O.

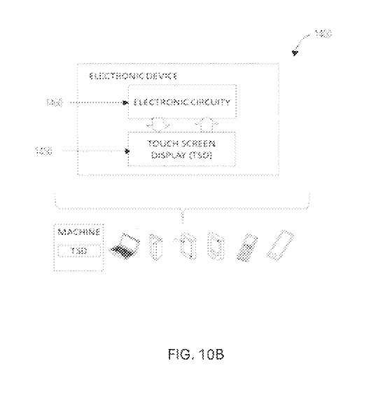

FIG. 11 illustrates a flowchart of a method 1500 for forming a touch screen display in accordance with one embodiment. The method 1500 of forming a touch screen display includes: providing the touch screen layer stack that includes a top surface layer; forming a touch screen coating composition, the touch screen coating composition comprising cerium oxide nanoparticles (CNPs) or silver cerium oxide nanoparticles (AgCNPs) as taught herein having a predominantly Ce³⁺ oxidation state and in a range of about 3-35 nm in size and in an amount that is in a range of about 1 weight percentage of a mixture having binder with the CNPs or AgCNPs where silver is non-ionizing; and coating the top surface layer while forming the coating composition that forms a self-disinfecting surface that is optically transparent.

The mixture further comprises: a dispersant additive including a copolymer with oxide-affinic groups or polymer non-ionic dispersing additive, and the binder includes polyvinyl pyrrolidone; and the forming of the coating composition further comprises mixing the dispersant and the binder.

A touch screen coating composition for coating a top surface layer of glass, includes a binder; and cerium oxide nanoparticles (CNPs) or silver cerium oxide nanoparticles (AgCNPs) as taught herein having a predominantly Ce³⁺ oxidation state and in a range of about 3-35 nm in size and in an amount that is in a range of about 1 weight percentage of a mixture having the binder and the CNPs or AgCNPs where the Ag is non-ionizing. The coating composition may include a dispersant additive including a copolymer with oxide-affinic groups or polymer non-ionic dispersing additive, and the binder includes polyvinylpyrrolidone.

The method 1500 may be performed in the order shown or a different order. One or more of the blocks or steps may be performed contemporaneously. Additionally, one or more blocks or steps may be added or deleted.

The method 1500 may include, at 1502, providing a touch screen layer stack that includes a top surface layer. The method 1500 may include, at 1504, forming a coating composition, the coating composition comprising cerium oxide nanoparticles (CNPs) or silver cerium oxide nanoparticles (AgCNPs) as taught herein having a predominantly Ce³⁺ oxidation state and in a range of about 3-30 nm or 3-35 nm in size and in an amount that is in a range of about 1 weight percentage of a mixture having a binder and the CNPs or AgCNPs. In some embodiments, the CNPs or AgCNPs being mixed with a dispersant prior to fabrication into ITO/binder.

The mixture of the coating composition may have a dispersant additive, a binder, or dispersant additive and binder with the CNPs or AgCNPs. The dispersant additive may include a copolymer with oxide-affinic groups or polymer non-ionic dispersing additive. The binder may include polyvinylpyrrolidone (PVP).

The method 1500 may include, at 1506, coating the top surface layer while forming the coating composition that forms a self-disinfecting surface that is optically transparent.

Other uses of the CNP or AgCNP ingredients as taught herein may include use in the treatment of wound healing.

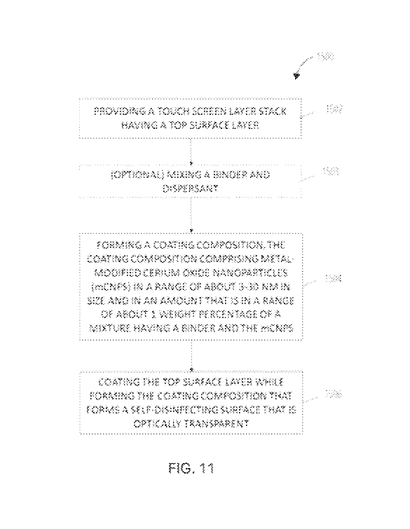

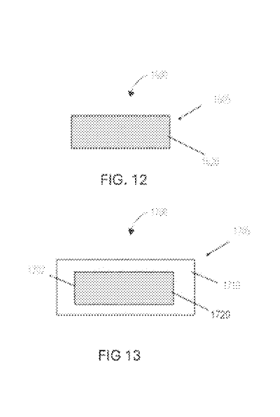

In some embodiments, treatments for wound healing may include applying a therapeutic dosage of wound healing composition to a fiber pad of a wound care article, described in relation to FIGS. 12-19 to form a wound healing article including both the wound care article and the therapeutic dosage of the wound healing composition.

In some embodiments, treatments for wound healing may include applying a therapeutic dosage of tissue glue, tissue adhesive, or surgical glue on the wound and covering or dressing a wound or surgical incision with a wound care article, described in relation to FIGS. 12‑19.

As described herein, the wound care articles, wound healing articles, and articles incorporating treated fiber material treated with a solution including a mixture of 0.01 wt% of CNPs or AgCNPs ingredient as taught herein and one or more of a binder, a dispersant, and a stabilizer, described herein, are a therapeutic article of manufacture. The CNP or AgCNP ingredient of the therapeutic article of manufacture includes CNP or AgCNP that have a predominant Ce³⁺ oxidation state, in a range of about 3-35 nanometers (nm) in size and has antimicrobial promoting properties.

The therapeutic article of manufacture includes treated fibers that eradicate bacteria, such as Streptococcus mutans and Staphylococcus aureus.

The therapeutic article of manufacture includes treated fibers that eradicate respiratory viruses, such as Rhinovirus 14, SARS-CoV-2 surrogate OC43 coronavirus and Parainfluenza virus type 5.

The therapeutic article of manufacture includes treated fibers that eradicate bacteria, such as Streptococcus mutans and Staphylococcus aureus, and viruses, such as Rhinovirus 14, SARS-CoV-2 surrogate OC43 coronavirus and Parainfluenza virus type 5.

The therapeutic article of manufacture includes treated fibers in a form factor designed as a barrier which can also treat a wound, incision or laceration formed in the epidermis or other anatomic tissue by preventing formation of bacteria, such as Streptococcus mutans and Staphylococcus aureus.

The therapeutic article of manufacture includes treated fibers in a form factor designed as a barrier which can protect the wearer from inhaled air from inspiration or inhalation that includes viruses, such as Rhinovirus 14, SARS-CoV-2 surrogate OC43 coronavirus and Parainfluenza virus type 5; and/or expiration particles that may include viruses, such as Rhinovirus 14, SARS-CoV-2 surrogate OC43 coronavirus and Parainfluenza virus type 5, trapped in the treated fibers.

The therapeutic article of manufacture includes treated fibers in a form factor designed as a barrier which can limit the spread of viruses, such as Rhinovirus 14, SARS-CoV-2 surrogate OC43 coronavirus and/or Parainfluenza virus type 5 upon expiration or exhalation of the wearer carrying such virus.

The therapeutic article of manufacture promotes wound healing and/or antimicrobial infection control.

FIG. 12 illustrates a wound care article 1600 according to an embodiment. The wound care article 1600 may include a body 1605 that includes a fiber pad with at least one layer or ply of material, denoted as numeral 1620. The material 1620 includes sterile fibers. The material fibers may be treated with a solution including a mixture of 0.01 wt% of CNP or AgCNP ingredient and one or more of a binder, a dispersant, and a stabilizer, wherein the CNP or AgCNP ingredient includes CNPs or AgCNPs that have a predominant Ce³⁺ oxidation state, a range of about 3-35 nanometers (nm) in size that has antimicrobial promoting properties. The wound care article 1600 may be a single-ply gauze material, a gauze pad, or a gauze sponge. The gauze pad may have multiple plies of gauze material.

A wound healing article may include a body having fibers treated with a mixture including a polymeric binder with cerium oxide nanoparticles (CNPs) or silver cerium oxide nanoparticles (AgCNPs) having a predominantly Ce³⁺ oxidation state. The CNPs or AgCNPs may be further mixed with a dispersant and/or stabilizer to promote adhesion with the binder and/or fibers. In some embodiments, the fibers may be formed of the mixture. The CNPs or AgCNPs may be in a range of about 3-35 nanometers (nm) in size. The CNPs or AgCNPs may be mixed in an amount that is in a range of about .01 to 0.8 weight percent of a mixture having the binder (or binder dispersant and/or stabilizer) and the CNPs or AgCNPs.

The polymeric binder may include a biocompatible polymer such as, without limitations, polyethylene glycol (PEG), poly(lactic-co-glycolic acid) (PLGA), PEG-PLGA copolymer, polycaprolactone (PCL), Polyvinylpyrrolidone (PVP), poly(2-ethyl-2-oxazoline) (PetOx) and polyurethane. The binder may include PetOx which has a CAS No. of 25805-17-8 and a molecular formula of [C₅H₉NO]n.

The dispersants and stabilizers may include, without limitation, a cellulose polymer, Bile acids sodium salt, cholic acid-deoxycholic acid sodium salt mixture, Alcohols, C12-14 secondary Ethoxylated Dodecyldimethylamine Oxide (DDAO), Polyethylene Glycol and a block copolymer surfactant. The dispersant and/or stabilizer promote adhesion with the binder and/or the fibers of the body.

The body 1605 may include a 4” x 4” 8-ply gauze sponge or pad, a 2” x 2” 4-ply gauze sponge or pad or a medical grade gauze sponge or pad. For example, the body 1605 may include an 8”x10”, 12” x 12” or 12” x 16” gauze sponge or pad for an abdomen for abdominal surgical incisions or lacerations. The body 1605 may include any number of layers (i.e., plies) and/or sizes for various parts of the anatomy. For example, the body 1605 may include 2-12 plies of cotton fiber material 1620. The body 1605 may be packaged individually in a sterile packing (not shown). The body 1605 may include a length of material that is rolled up or wound to form a bandage roll. The gauze material may be available in a variety of thread counts.

In some embodiments, the term “treated” may include drying or curing a sterile solution with 0.01 wt% of CNP or AgCNP ingredient, such as CNPs or AgCNPs in a range of about 3-35 nanometers (nm) in size, on the fibers of material 1620.

In some embodiments, the fiber material 1620 may be a blend of material fibers. The fiber material may include one or more of polymers, yarns, cotton, and synthetic polymer fibers. In some embodiments, the fiber material 1620 may include 100% cotton. The blend of material fibers may include spandex such that the material stretches and/or provides compression to the wound sight when the wound care article is wrapped around a wound. The fiber material 120 may include a moisture-wicking fibers. The fiber material 1620 may include a ply of woven fibers and a ply of non-woven fibers. The fiber material 1620 may be a non-adhesive material that includes non-adherent fibers that will not stick to a wound.

For example, the material may include a Celox™ gauze material with quick clotting properties.

The wound care article 1600 may be a sterile burn dressing. The material may be a gel-soaked medical-grade non-woven material. The wound care article 1600 or material 1620 may be First Aid Only FAE-3000 series, FAE-5000 series and FAE-7012 compliant. The wound care article 1600 may include hydrogel impregnated non-adherent gauze. The hydrogel impregnated non-adherent gauze provides a moist healing environment around the wound wherein the hydrogel (such as, without limitation, PEG or a PEG-PLGA copolymer) is mixed with 0.01 wt% of CNPs AgCNPs, as taught herein, ingredient that has a predominant Ce³⁺ oxidation state and in a range of about 3-35 nanometers (nm) in size and that has antimicrobial promoting properties.

In some embodiments, the treated fiber material 1620 may have a form factor of an ace bandage with elastic fibers. For example, the treated fiber material 1620 may be a sterile self-adherent wrap material. Self-adherent wrap material is made by 3M™ Company using a trademark COBAN.

In some embodiments, the treated fiber material 1620 compatible with FAE-7012 is used for the treatment of skin burns.

In some embodiments, the treated fiber material 1620 treated with a mixture having the CNP ingredient may have a form factor of STERI-STRIP, such as manufactured by 3M™ Company in Saint Paul, MN, or thin adhesive bandages made by other manufacturers that can be used to close a laceration that may or may not have sutures to hold the skin together.

In some embodiments, the treated fiber material 1620 treated with a mixture including the CNP or AgCNP ingredient may be integrated into an advanced dressing containing biological or naturally derived agents. In some embodiments, the treated fiber material 1620 treated with the CNP or AgCNP ingredient may be integrated into an advanced dressing containing biological or naturally derived agents.

The treated fiber material 1620 may have a face mask form factor to prevent or limit spreading a respiratory track illness or lung disease. The treated fiber material 1620 may have a face mask form factor for the treatment of a wound to a lung or respiratory track injury from a biological or chemical inhalation or disease. In this case, the fiber material 1620 is applied to cover the nostrils of the wearer’s nose or mouth. If the wearer exhales a virus, the treated fiber material 1620 traps the virus to treat the virus, which eradicates the virus to prevent or limit the spread of the virus. The treated fiber material 1620 may also be used to prevent or limit the re-inhalation of the virus by the wearer or inhalation of the virus from the ambient air of the environment.

The treated fiber material 1620 may have a replaceable filter form factor configured to be inserted into a face mask or professional breathing protection devices for prevention of wounds or injury to the respiratory track or lungs from Rhinovirus 14, SARS-CoV-2 surrogate OC43 coronavirus and Parainfluenza virus type 5.

The treated fiber material 1620 may have N95 Respirator Mask form factor or KN95 Respirator Mask.

The treated fiber material may have a Respirator Mask form factor.

In some embodiments, the treated fiber material 1620 treated with a mixture with the CNP or AgCNP ingredient may be integrated into anti-inflammatory and analgesic dressing.

In some embodiments, the treated fiber material 1620 may include impregnated fibers with a wound healing composition described herein.

FIG. 13 illustrates a wound care article 1700 according to an embodiment. The wound care article 1700 may include a body 1705 having a first layer 1707 having a pad of fiber material 1720 treated with a solution including 0.01 wt% of CNP or AgCNP ingredient and one of or a combination of polymeric binder, a dispersant, and a stabilizer, the CNPs and AgCNPs ingredient has a predominant Ce³⁺ oxidation state and in a range of about 3-35 nanometers (nm) in size and has antimicrobial promoting properties. The first layer 1707 may include at least one layer or ply of a fiber material 1720 (i.e., fiber material 1620) or other fibers described above in relation to FIG. 12.

The wound care article 1700 may include a second layer 1710. The second layer 1710 is shown hatched with dots. The second layer 1710 may be a waterproof layer of material with a coating of low tactile adhesive or glue compatible for adhesion directly onto the surface of skin. The second layer 1710 may be a pressure sensitive adhesive layer that adheres to the skin by application of pressure to the low-tactile adhesive. The adhesive layer may be a high-grab/instant tack adhesive. The wound care article 1700 may be compatible with International Standardization Organization (ISO) 10993 for medical bandages.

The second layer 1710 may be an adhesive strip constructed from thin films (or other types of polymers) such as, without limitations, made from polyurethane or polyethylene, and provide high-grab/instant tack adhesive. The thin films may be such as manufactured by 3M™ Company in Stain Paul, MN.

In some embodiments, the treated fiber material 1720 treated with the CNP ingredient may have a form factor of gauze fibers incorporated into transparent thin films, such as in a 3M™ TAGADERM roll with a transparent film dressing, such as manufactured to 3M™ Company in Saint Paul, MN. An amount of about 0.8 wt% of CNPs or AgCNPs may be incorporated directly into the adhesive layer of the dressing, in a similar fashion to incorporation into fibers.

In some embodiments, the second layer 1710 may include elastic fibers and with a length to surround a portion of the anatomy, such as a wrist, arm, leg, foot, abdomen, chest, and head. The elastic fibers may stretch to provide a compressive force around the body with the fiber pad of the first layer overlaying the wound or incision.

The second layer 1710 may be affixed to the first layer 1707 so that both the first layer 1707 and the second layer 1710 are applied essentially together to a wound and surrounding skin. Alternately, the second layer 1710 may be a separate distinct layer that can be individually applied over the first layer 1707 when treating a wound.

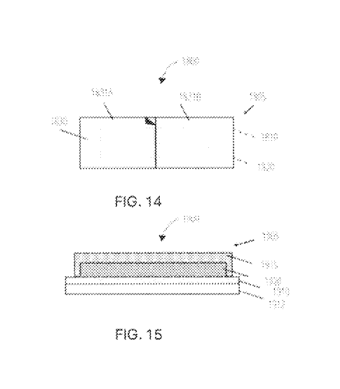

FIG. 14 illustrates a wound care article 1800 according to an embodiment. The wound care article 1800 may include a body 1805 having a fiber material 1820 (i.e., fiber material 1620) with a third layer 1830 comprising at least one peel-off liner 1831A, 1831B. In this example, the wound care article 1800 may include two peel-off liners 1831A, 1831B, which can be peeled away to expose the fiber material 1820 and the second layer 1810 including an adhesive strip. The third layer 1830 may overlay the treated fibers of the fiber pad and the low-tactile adhesive to protect the treated fibers and the low-tactile adhesive until use. The wound care articles 1600, 1700 and 1800 having a treated fiber pad that is treated with an amount of CNP or AgCNP may be used without a wound healing composition, an epithelial tissue healing agent, tissue glue, tissue adhesive, or surgical glue mixed with an amount of CNPs or AgCNPs, described herein. The wound care articles 1600, 1700 and 1800 having a treated fiber pad may be used alone as a wound healing article to protect wounds or incisions from incubation of viruses or bacteria. The wound care articles 1600, 1700 and 1800 may be applied over surgical staples or medical stitches. The wound care articles 1600, 1700 and 1800 may be changed periodically and replaced with new wound care articles as part of a wound care healing treatment regime.

FIG. 15 illustrates a wound healing article 1900 according to an embodiment. The wound healing article 1900 may include a body 1905 having a waterproof layer 1912 with an adhesive layer 1910. The waterproof layer 1912 and the adhesive layer 1910 may include sublayers that are combined into a single layer. The layer 1910 may include a thin-film adhesive that includes a low-tactile adhesive material or high-grab/instant tack adhesive material. In some embodiments, the waterproof layer 1912 and adhesive layer 1910 may include a self-adherent wrap material. The wound healing article 1900 may include, in the body 1905, a matrix layer 1915 with open pores or a semipermeable membrane which are non-adherent materials. The matrix layer 1915 may comprise non-adherent material.

The waterproof layer 1912 has a first side that is intended to be exposed when in use. The waterproof layer 1912 includes a second side to which the adhesive layer 1910 is applied or incorporated.

The wound healing article 1900 may include, in the body 1905, a pad 1920 impregnated with or formed of a mixture or composite that includes an amount of eitherCNP or AgCNP ingredient that has a predominant Ce³⁺ oxidation state and in a range of about 3-35 nanometers (nm) in size and has antimicrobial promoting properties. For example, the composite may include a mixture of either CNP or AgCNP ingredient and a therapeutic dosage of epithelial tissue healing agent or wound healing agent. For example, the composite may include a mixture of a hydrogel and the CNP or AgCNP ingredient which forms a therapeutic dosage of epithelial tissue healing composite. The pad 1920 may be surrounded by the matrix layer 1915. However, a portion extends beyond the perimeter edges of the waterproof layer 1912 and the adhesive layer 1910 so that enough surface area is exposed to adhesively bond the wound healing article 1900 to the skin of a patient.

Wound healing article 1900 may include peel-off liners 2030 of FIG. 16.

Wound treatment may include applying the wound healing article 1900 to a wound by overlapping a wound or incision with the pad 1920 and applying pressure to the waterproof layer 1912 and the adhesive layer 1910. Additionally, applying slight pressure with a finger to the waterproof layer 1912 over the area of the pad 1920 causes a therapeutic dosage of epithelial tissue healing composite to pass through the open pores or the semipermeable membrane and onto the wound.

The non-adherent semipermeable membrane or non-adherent porous material of body 1905 on top of and surrounding the treated fibers is used to dispense the therapeutic dosage of epithelial tissue healing agent or the wound healing agent through the non-adherent semipermeable membrane or the non-adherent porous material.

FIG. 16 illustrates a wound healing article 2000 according to an embodiment. The wound healing article 2000 may include a body 2005 having a waterproof layer 2012 with an adhesive layer 2010. The waterproof layer 2012 and the adhesive layer 2010 may include sublayers that are combined into a single layer. The layer 2010 may include a low-tactile adhesive material or high-grab/instant tack adhesive material.

The wound healing article 2000 may include, in the body 2005, a pad 2020 impregnated with or formed of a mixture that includes an amount of CNPs or AgCNPs having a predominant Ce³⁺ oxidation state and in a range of about 3-35 nanometers (nm) in size that has antimicrobial promoting properties. The pad may include treated fibers that are impregnated with a healing wound composite. For example, the healing wound composite may include a mixture of either the CNP or AgCNP ingredient and a therapeutic dosage of epithelial tissue healing agent.

The treated fibers may be impregnated fibers impregnated with or formed of a mixture including one or more of a binder, a dispersant, and a stabilizer; CNPs or AgCNP that have a predominant Ce³⁺ oxidation state and in the range of about 3-35 nanometers (nm) in size; and a therapeutic dosage of epithelial tissue healing agent.

The wound healing article 2000 may include, in the body 2005, at least one liner 2030 to cover and protect the pad 2020 and or the mixture or composite.

In some embodiments, the bodies 1605, 1705, 1805, 1905 and 2005 include one of bandages and dressings.

Any of the layers of articles 1600, 1700, 1800, 1900 and 2000 may be used or substituted in the other articles 1700, 1800, 1900 and 2000.

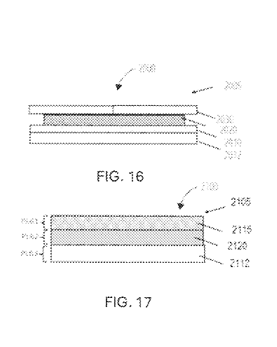

FIG. 17 illustrates a wound healing article 2100 having a body 2105 with a three-ply structure according to an embodiment. The body includes a first ply PL61, a second ply PL62 and a third ply PL63. The first ply PL61 may include a first material or fabric 2115. In some embodiments, the first material or fabric 2115 may be a non-adherent material suitable for dressings or bandages. The second ply PL62 may include treated fiber material 2120 (i.e., treated fiber material 1620) treated with either the CNP or AgCNP ingredient. The CNP and AgCNP ingredient having a predominant 3+ cerium charge and in a range of about 3-35 nanometers (nm) in size. The treated fiber material 2120 may be treated with a mixture including the CNPs or AgCNPs and one or more of a polymeric binder, a dispersant, and a stabilizer. The CNP or AgCNP ingredient is mixed in an amount that is in a range of about .01 to 0.8 weight percent of the mixture.

The third ply PL63 includes a third material or fabric 2112. The third material or fabric 2112 may be the same material or different as the first material or fabric 2115. In some embodiments, the first and third material or fabric 2115 and 2112 may be untreated gauze or 100a% cotton with the second ply PL62 being treated gauze fibers, for example. In other embodiments, the first and third material or fabric 2115 may be N95 Respirator Mask materials with an interior embedded layer corresponding to the second ply PL62 with treated fiber material 2120 (i.e., fiber material 1620).

In some embodiments, a ply may include one or more layers of a fabric or material for a dressing or bandage.

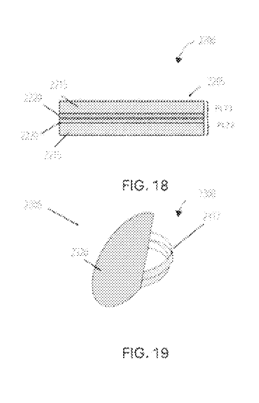

FIG. 18 illustrates a wound healing article 2200 having body 2205 with a two-ply structure according to an embodiment. The body 2205 includes a first ply PL71 and a second ply PL72. The first ply PL71 may include a first material or fabric 2215. The second ply PL72 may include the first material or fabric 2215. A portion of the first ply PL71 and the second ply PL72 includes treated fiber material 2220 treated with an CNP ingredient, as described above in relation to FIG. 18. The body 2205 includes stacked plies where directly opposing or interior surfaces of the first and second plies PL71 and PL72 are treated fiber material 2220 treated with a mixture including either the CNPs or AgCNPs and one or more of a polymeric binder, a dispersant, and a stabilizer. The CNP or AgCNP ingredient is mixed in an amount that is in a range of about .01 to 0.1 weight percent of the mixture.

FIG. 19 illustrates a side view of a wound healing article 2300 with a face mask form factor according to an embodiment. The body 2305 of the wound healing article 2300 may include at least one ply or layer of treated fiber material 2320. The body 2305 may include straps 2317, one on each side of the body 2305, configured to be worn about ears of a wearer. Alternately, the body 2305 may include at least one strap 2317 having one end attached to a first side of the body and a second end attached to a second end of the body so that the at least one strap 2317 may be placed around the back of a head or neck of the wearer. The body 2305 may include two-ply structure shown in FIG. 12 or a three-ply structure shown in FIG. 16, for example.

The wound healing articles may be applied to at least one of the mouth and nose or areas adjacent to the breath stream from at least one of the mouth and nose. The wound healing articles described herein may be used to continually reduce the viral load near the mouth and nose and also prevent bacterial growth (from Streptococcus mutans and Staphylococcus aureus) that are commonly found near a person’s nose and mouth.

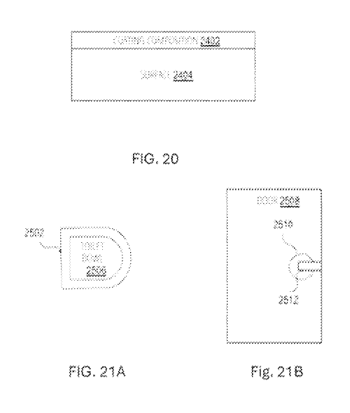

FIG. 20 shows a surface 2402 of an article coated with a coating composition 2404 such as a NanoRAD coating, as described herein. The surface 2402 may be any hard surface such as cabinets, walls, sinks, toilets, countertops, floors, cars, ships, marine surfaces, computing devices, electronic devices, furniture, doorknobs, faucets, hospital beds, night tables, appliances, toys, and more. The surface 2402 may include man-made materials, metal, porcelain, ceramic, cement, wood, engineered wood, and engineered synthetic materials, for example. The surface 2402 may include a soft surface made of fibers, such as fabric, textile, and carpet. The coating composition 2404 may include clearcoat ingredients that are suitable for the particular surface application.

The soft surface may be made of fibers, paper or soft plastics or synthetic ingredients such as used to cover menus.

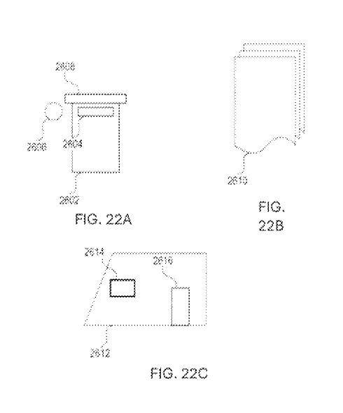

Example articles are shown in FIGS. 21A, 21B and 22A-22C. As should be understood, showing, and describing each and every possible article is prohibitive.

FIG. 21A illustrates a toilet seat 2502 coated with a coating composition, such as a NanoRAD coating, in accordance with one embodiment. The toilet seat 2502 may be mounted on a toilet bowl 2506. The toilet bowl 2506 may be made of porcelain while the toilet seat 2502 may be made of plastic, wood, or synthetic materials. Both the toilet seat 2502 and toilet bowl 2506 may be coated with different coating compositions 2404.

FIG. 21B illustrates a door 2508 with a door handle 2512 affixed to a plate 2510 in accordance with one embodiment. The door 2508 may be coated with a first coating composition 2404, such as a NanoRAD coating, while the door handle 2512 and plate 2510 may be coated with a second coating composition 2404, such as another NanoRAD coating, different from the first coating composition.

FIG. 22A illustrates furniture such as nightstand 2606 and headboard 2608 coated with a coating composition, such as a NanoRAD coating, in accordance with one embodiment. In some embodiments, the headboard 2608 is attached to a bed 2602 having a pillow 2604. The nightstand 2606 and headboard 2608 may be coated with a coating composition 2404. In some embodiments, the nightstand 2606 and headboard 2608 may be made of similar material which is suitable for using a coating composition 2404 of the same type. In other instances, the nightstand 2606 and headboard 2608 may be made of different types of material requiring different NanoRAD coating compositions 2404.

FIG. 22B illustrates fabric 2610 coated with a NanoRAD coating in accordance with one embodiment. The fabric 2610 may include fibers that are configured to be coated with a coating composition 2404. The fabric 2610 may be used for curtains, for example, in a hospital, office, hotel, public location, residence, or building. The fabric 2610 may be used on soft surfaces, such as cushion chairs, sofas, beds, and the like.

The fabric 2610 may be made into a paper product.

FIG. 22C illustrates an interior wall 2612 of a building having a door 2616 and a window 2614 in accordance with one embodiment.

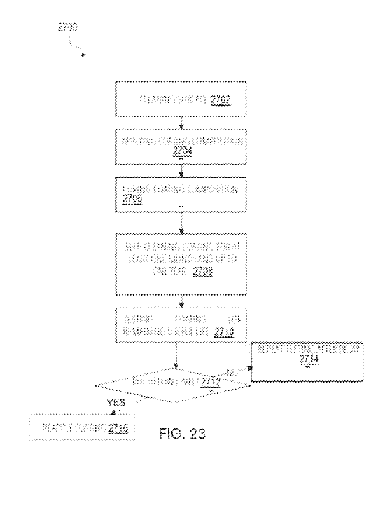

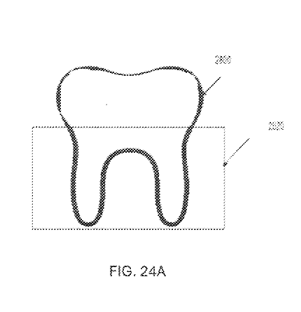

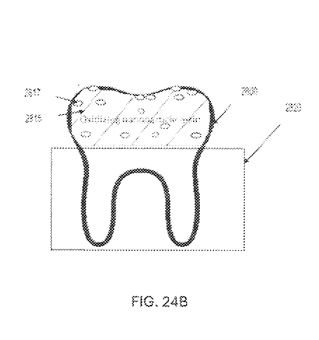

FIG. 23 illustrates a flowchart of a process 2718 for coating a surface in accordance with one embodiment. The process 2718, in block 2702, may include cleaning a subject surface. While it may be recommended to clean the subject surface with a cleaner to remove bacteria and organic material, it may be impossible to remove all bacteria and resistant bacteria. The NanoRAD coating described herein eradicates bacteria and biofilms on the surface after the NanoRAD coating is applied and permanently affixed, for example.

In block 2704, the process 2818 may include applying a NanoRAD coating composition to the subject surface. In block 2706, the process 2718 may include curing or hardening the NanoRAD coating composition to form and affix the NanoRAD coating to the surface of the article. In some embodiments, the curing is performed using a UV light, for example, having a wavelength range of 200 nm to 400 nm. The NanoRAD coating composition 104 may harden or cure in response to an application of UV light in the wavelength range of 200 nm to 400 nm over a period of time. In other embodiments, the NanoRAD coating composition 2404 may be hardened or cured in response to an evaporation of water or application of radiated heat.

In block 2708, the process 2718 may include continuously and autonomously self-cleaning and/or self-disinfecting the NanoRAD coating for at least one month and up to one year. In block 2710, the process 2718 may include testing the NanoRAD coating for remaining useful life (RUL). It should be understood that the NanoRAD coating may be cleaned using commercially available cleaners, such as those applied by spraying and wiping, to remove organic material that may be deposited from interaction with humans or animals. Such cleaning is secondary to the self-cleaning and/or self-disinfecting by the NanoRAD coating to eradicate bacteria, viruses, and biofilms, for example.

In decision block 2712, a determination is made whether the RUL is below a level. If the determination is “NO,” then at block 2714, the process 2718 may include repeat testing after a delay, for example, testing may be repeated daily, weekly, monthly, quarterly, etc. The delay may vary based on the determined RUL level. If the determination is “YES,” then, at block 2716, the process 2718 may include reapplying the coating composition.

The RUL level may be determined using image processing, where the pixels are analyzed based on the appearance of the fluorescing additive. For example, in a region of interest (ROI), if 5% (RUL threshold) of the pixels are not fluorescing, the NanoRAD coating may need to have a new application of the NanoRAD coating over the existing NanoRAD coating. In other examples, the NanoRAD coating in the ROI is greater than the RUL threshold, the entire coating in at least the ROI may be removed so that a new NanoRAD coating can be reapplied. The RUL threshold may be between 5% and 10%. In other embodiments, the RUL threshold may vary based on the article and exposure to frequency of touch by humans or animals.

The coating method may be applied during the manufacturing process of a hard or soft surface article or in the building. In some embodiments, the coating may be sprayed on to the surface. In other embodiments, the coating may be applied in any manner as a paint is applied, such as with a paint brush. During the manufacturing process, the NanoRAD coating composition may be applied during an additive manufacturing process.

The CNP or AgCNP ingredient can be combined into a composite with many forms of dental resins or sealants that may be applied to the teeth or the back teeth such as, without limitation, premolars, and molars. Premolars may include maxillary first premolar, maxillary second premolar, mandibular first premolar and mandibular second premolar. Molars may include first molars, second molars and third molars. Third molars are known as wisdom teeth which appear generally between 17 and 21 years of age, but may be removed earlier by surgery.

Therefore, in some embodiments, multiple applications of a dental resin composite may be needed. The resin or sealant may be applied to a non-permanent teeth and then subsequently, applied to permanent teeth.

There are many dental resins and sealants readily available on the market. In some embodiments, the dental appropriate resin composite may be a light-curable resin composite. The dental resin composite is applied in a therapeutically effective amount to coat the teeth. The amount of CNPs or AgCNPs mixed or dissolved in the dental resin composite in an amount that is a therapeutically effective amount.

Example resin composites are described in U.S. Patent No. 4,826,893, titled “DENTAL RESIN COMPOSITION,” to Yamazaki et al., incorporated herein by reference in its entirety.

In some embodiments, acrylic-based polymer resins such as methyl methacrylate-based resin systems that include other monomer polymers and fillers are appropriate types of resin composites.

A methyl methacrylate-based dental resin may include a methyl methacrylate polymer resin (heat cured or self-cured or light cured) such as polymethyl methacrylate, a polymethyl methacrylate curing process that is initiated by tertiary and amine compounds.

The methyl methacrylate-based dental resin may include monomer polymers and fillers where a poly methyl methacrylate (PMMA) powder incorporates a filler such as silica, titania, or zirconia, and includes an initiator such as benzoyl peroxide. The methyl methacrylate-based dental resin may include a liquid component containing methyl methacrylate (MMA) monomer, with a crosslinking agent and inhibitor, where a combination of liquid with powder components initiates polymerization.

The methyl methacrylate-based dental resin may include PMMA powder, methacrylate monomer polymers and fillers such as titania and silica.

Another example resin composite is described in Published Application WO/201701886, titled "PHOTOPOLYMERISABLE RESIN COMPOSITE AND USE THEREOF,” to DeOliveira, et al., incorporated herein by reference in its entirety. For example, the dental resin comprises a photopolimerisable resin composite with a higher filler particle content and a resin matrix of dimethacrylate monomers which are polymerized by free radical reaction initiated by the synergy of photoinitiator systems based on camphorquinone and (2,4,6-trimethylbenzoyl) diphenylphosphine oxide with monomer systems such as Bisphenol A Glycyl Dimethacrylate (Bis-GMA), Urethane Dimethacrylate (UDMA) Hydroxyethyl Methacrylate Phosphate (HEMA-P), glycerol dimethacrylate dihydrogen phosphate and mixtures of similar monomers.

A UDMA-based dental resin may include a photopolimerisable resin composite such as UDMA with a higher filler particle content and a resin matrix of dimethacrylate monomers, which are polymerized by free radical reaction initiated by the synergy of photoinitiator systems based on camphorquinone and (2,4,6-trimethylbenzoyl) diphenylphosphine oxide.

In some embodiments, Urethane Dimethacrylate-based dental resins (that can include other monomers and fillers) may be used, as described in A. Szczesio-Wlodarczyk et al., “An Evaluation of the Properties of Urethane Dimethacrylate-Based Dental Resins,” www.mdpi.com/1996-1944/4/1/2727/htm, incorporated herein by reference in its entirety.

A urethane dimethacrylate-based dental resin is light curable and may include UMDA combined with ethoxylated bisphenol-A dimethacrylate, for example.

Nanoparticles have been known to improve impact strength of dental acrylic resins. [Shcherbakov et al., titled “CeO2 Nanoparticles-Containing Polymers for Biomedical Applications: A Review, 17 Mar. 2021, Polymers 2021, 3, 924, www.doi.org/10.3390/polym3060924.]

The method of preventing dental caries will be described in relation to FIGS. 24A, 24B and 25-27. The method of preventing dental caries may include forming a dental resin composite with CNPs or AgCNPs in the amount of about .01-.1 wt. %. The method may include cleaning a subject’s teeth to remove surface contaminates. In some embodiments, surface contaminants may include plaque. Surface contaminants may include food particles, which may be embedded in the depressions or grooves naturally occurring or worn in the surface of a tooth or between surfaces of adjacent teeth.

FIG. 24A illustrates a subject tooth 2800 in a clean state. The tooth 2800 is represented in the gums 2820 of a subject. FIG. 24B illustrates a subject tooth 2800 of FIG. 24A with a coating 2815 of dental resin composite including CNP or AgCNP 2817, coated on the tooth 2800. Specifically, the dental resin composite including CNPs or AgCNPs may be coated on the enamel of the tooth which is the outer surface of the tooth above the gums.

After the tooth surface (i.e., enamel) has been cleaned, the dental resin composite including CNPs or AgCNPs may be coated on the enamel of the tooth 2800. In some embodiments, the coating 2815 of the composite is cured. For example, the dental resin composite may be light cured. For example, an ultraviolet light (UV) source may be used. The curing process hardens the dental resin composite including CNPs or AgCNPs on the tooth’s surface.

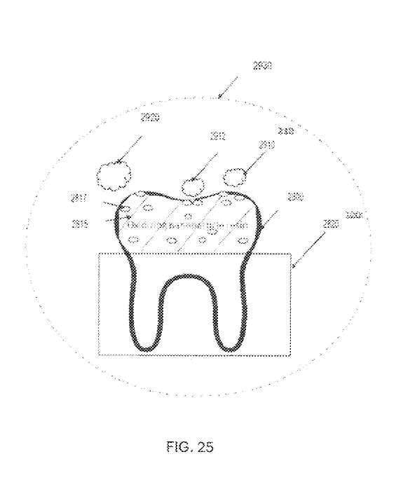

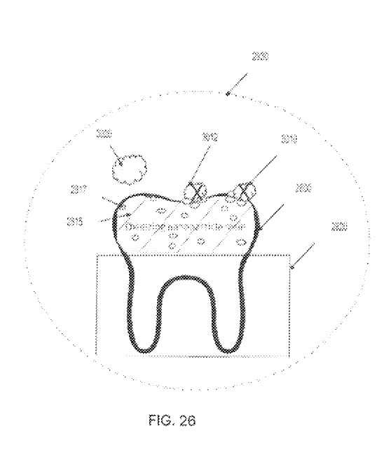

FIG. 25 illustrates a coated subject tooth 2800 of FIG. 24B in the mouth 2930 with bacteria 2910, 2912 and 2920. FIG. 26 illustrates a coated subject tooth 2800 of FIG. 25 releasing directed hydrogen peroxide (H₂O₂) to degrade or destroy caries-causing bacteria, denoted by 3010 and 3012. Bacteria that cause dental caries may include bacteria that feed on sugar, including carbohydrates that are left in the mouth. This bacteria may include, without limitation, streptococcus mutans, such as Streptococcus sobrinus, and lactobacilli acidophilus. The inventor has determined covering the tooth with cured dental resin composite with the cerium oxide nanoparticles (CNPs) or silver cerium oxide nanoparticles (AgCNPs) 2817, described herein, causes the autonomous release, from the CNP or AgCNP, hydrogen peroxide directed against bacteria in an oral cavity to prevent local acidification of the tooth and prevents further decay. The release of hydrogen peroxide is a non-indiscriminate release in the body and generally limited to release for destroying bacteria having a propensity to colonize on teeth.

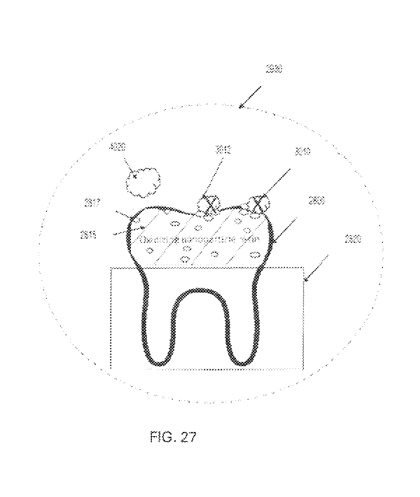

FIG. 27 illustrates the coated subject tooth 2800 of FIG. 25 with the bacteria 3010 and 3012 degraded or destroyed. The bacteria 4020 may be a different type of bacteria that does not have a propensity to colonize on teeth. Therefore, the CNP or AgCNP 2817, as described herein, may not release hydrogen peroxide to destroy bacteria that do not make sustained contact with a treated tooth 4020.

The embodiments herein incorporate by reference in full U.S. Application No. 17/973,640, titled “NANOPARTICLES TO PROMOTE WOUND HEALING AND ANTIMICROBIAL INFECTION CONTROL,” filed Oct. 26, 2022.

The wound healing composition for the epithelial tissue including skin or eye tissue to target the oxidizing response need to kill viruses and bacteria to the virus and bacteria. Additionally, wound healing composition may include an epithelial tissue healing agent and CNPs or AgCNPs, which acts as an antioxidant in the presence of healthy cells, promoting lower inflammation and cell growth. This allows for quicker closure of the wound while assuring that any trapped bacteria will not lead to an infection. The nature of the wound healing composition is that it works against a broad range of viruses and bacteria.

The epithelial tissue healing agent may be selected from a group consisting of preadipocyte modulator and an adipocyte modulator and contain in a pharmaceutically acceptable composition for subcutaneous administration, as described in U.S. Patent No. 7,638,484, incorporated herein by reference in its entirety.

The epithelial tissue healing agent may include a therapeutically effective amount of a viral vector comprising a polynucleotide coding for an adipokine, as described in U.S. Patent No. 7,638,484.

The skin cells colonizing the damaged skin or skin wound may be of any cell type which is involved in the wound healing process, such as keratinocytes, fibroblasts, adipocytes or preadipocytes. The cells can be transformed by a polynucleotide encoding an adipokine as defined hereinbefore. Alternatively, the cells can be transformed by a polynucleotide encoding a polypeptide capable of an adipokine activity, such as the polynucleotide encoding adipsin/complement D activity described in U.S. Patent No. 5,223,425, incorporated by reference.

The suitable polynucleotide can be introduced into cells by any one of a variety of known methods within the art. Such methods are generally described in Sambrook et al., (1989, 1992), Ausubel et al., (1989), Chang et al., (1995), Vega et al., (1995), Rodriguez and Denhardt (1988) and Gilboa et al., (1986), and include, for example, stable or transient transfection, lipofection, electroporation and infection with recombinant viral vectors. U.S. Patent No. 4,866,042 discloses a list of vectors involving the central nervous system, and U.S. Patent Nos. 5,464,764 and 5,487,992 describe positive-negative selection methods for inducing homologous recombination, all of which patents are incorporated herein by reference.

The wound healing composition may include a tissue adhesive or glue and cerium oxide nanoparticles (CNPs) or silver cerium oxide nanoparticles (AgCNPs) as taught herein in a range of about 3-5 nm in size and mixed in an amount that is in a range of about 0.01 to 0.8 weight percent of a mixture having the tissue adhesive and the CNPs or AgCNPs.

The tissue adhesive or glue formulation may include the components for delivery and administration to a surgical incision or wound.

In certain embodiments, the tissue glue may include a fibrin glue. Fibrin glue as a surgical adhesive is well known in the art. The tissue glue may include hydrogels comprising, for example, but not limited to, polyethylene glycol (PEG), fibrin, dextrans, including dextrans suitable for chemical crosslinking and/or photo-crosslinking, albumin, polyacrylamide, polyglycolic acid (PGA), polyvinyl chloride, polyvinyl alcohol, poly(n-vinyl-2-pyrollidone), poly(2-hydroxy ethyl methacrylate), hydrophilic polyurethanes, acrylic derivatives, pluronics, such as polypropylene oxide and polyethylene oxide copolymer (POC), or the like.

The use of fibrin glue as a skin adhesive for closing surgical incisions is well known in the art. The glue compositions may also include additional components such as liposomes, for example. Example, fibrin glue compositions are disclosed in U.S. Patent No. 5,290,552, which is incorporated by reference.

In certain embodiments, the adhesive or glue may comprise non-degradable materials, for example, but not limited to, expanded polytetrafluoroethylene (ePTFE), polytetrafluoroethylene (PTFE), polyethyleneterephthalate (PET), polyurethane, polyethylene, polycarbonate, polystyrene, silicone, and the like, or selectively degradable materials, such as poly (lactic-co-glycolic acid; PLGA), polylactic acid (PLA), or PGA.

In certain embodiments, the surgical glue or adhesive may be a photo-activated glue, acrylate-based adhesives, and the like.

Example synthetic hydrogels may include polyphosphazenes, poly (vinyl alcohol) (PVA), and an interpenetrating and semi-interpenetrating hydrogels (e.g., PEO, and PEO-PEO-dimethylacrylate blends).

Example tissue adhesives may be a single component adhesive or multi-component adhesive. Further suitable adhesives include synthetic adhesives and/or natural adhesives. Suitable biocompatible adhesives for use in the wound healing composition include commercially available surgical adhesives, such as cyanoacrylate (such as 2-octyl cyanoacrylate, Dermabond™) and fibrin glue (such as Tissucol®).

There are many tissue glues, surgical glues, or tissue adhesives readily available on the market. The healing wound composition is applied in a therapeutically effective amount to the wound to close the wound. The amount of the CNP or AgCNP ingredient as taught herein is mixed or dissolved in the wound healing composition in an amount that is a therapeutically effective amount with a surgical adhesive or glue.

The wound healing composition may include a solid composition or a liquid composition, by way of non-limiting example. For a solid composition of a pharmaceutically acceptable composition, conventional nontoxic solid carriers include, for example, pharmaceutical grades of mannitol, starch, magnesium stearate, talc, lactose, glucose, sucrose, sodium saccharin, magnesium carbonate, cellulose, and the like. For liquid pharmaceutically acceptable compositions, the pharmaceutically acceptable composition may be prepared by dissolving, dispersing, mixing, etc., an active compound, as described herein, and optional pharmaceutical adjuvants in an excipient such as, for example, saline, water, aqueous dextrose, ethanol, glycerol, and the like, to thereby form a solution or suspension. The pharmaceutical acceptable composition may contain minor amounts of nontoxic auxiliary substances such as wetting or emulsifying agents, pH buffering agents and the like, for example, sorbitan mono-laurate, sodium acetate, triethanolamine oleate, triethanolamine acetate, etc. Specifically, the wound healing composition includes an amount of CNPs or AgCNPs mixed or dissolved in the wound healing composition includes about 0.01 to 0.8 weight percent (wt%).

Methods of preparing dosage forms of the pharmaceutical acceptable composition are known, or will be apparent, to those skilled in this art. For oral administration, the pharmaceutical acceptable composition will generally take the form of a tablet or capsule, or may be an aqueous or nonaqueous solution, suspension, or syrup. Tablets and capsules for oral use will generally include one or more commonly used carriers such as lactose and corn starch. Lubricating agents, such as magnesium stearate, are also typically added. When liquid suspensions are used, the active agent may be combined with emulsifying and suspending agents. If desired, flavoring, coloring and/or sweetening agents may be added as well. Other optional components for incorporation into an oral formulation of the pharmaceutical acceptable composition herein include, but are not limited to, preservatives, suspending agents, thickening agents, and the like. One skilled in this art may further formulate the pharmaceutical acceptable composition in an appropriate manner, and in accordance with accepted practices, such as those disclosed in Remington's Pharmaceutical Sciences, Gennaro, Ed., Mack Publishing Co., Easton, Pa. 1990.

The embodiments herein incorporate by reference in full U.S. Application No. 17/973,769, titled “THERAPEUTIC ARTICLE OF MANUFACTURE WITH NANOPARTICLES TO PROMOTE WOUND HEALING AND/OR ANTIMICROBIAL INFECTION CONTROL,” filed Oct. 26, 2022.

The embodiments herein incorporate by reference in full U.S. Application No. 18/090,693, titled “CONTINUOUS SELF-DISINFECTING AND PATHOGEN ERADICATING COATING, ARTICLE OF MANUFACTURE WITH THE COATING AND METHOD OF APPLICATION,” filed Dec. 29, 2022.

The embodiments herein incorporate by reference in full U.S. Application No. 17/973,720, titled “METAL-MODIFIED NANOPARTICLE ENABLED DENTAL RESINS FOR PREVENTION OF DENTAL CARIES,” filed Oct. 26, 2022.

The embodiments herein incorporate by reference in full U.S. Application No. 17/973,822, titled “ELECTRONIC DEVICE WITH SELF-DISINFECTING TOUCH SCREEN AND METHOD OF MANUFACTURE,” filed Oct. 26, 2022.

In one embodiment, a process for manufacturing cerium oxide nanoparticles (CNPs) or silver cerium oxide nanoparticles (AgCNPs) is provided. The process includes using a process with at least one accelerant that speeds up the peroxy ligand conversion of CNPs or AgCNPs having a predominant Ce³⁺ oxidation state, the at least one accelerant that accelerates evolution to crystallize onto cerium oxide nanoparticles as a non-ionized phase is selected from the group consisting of: low heat of 90°-115° F during an aging process during which peroxy ligand conversion takes place; food grade or wholly un-stabilized hydrogen peroxide; and a form factor ratio of a vessel in which the CNPs or AgCNPs age during the ageing process.

In one embodiment, a wound healing composition is provided that includes a tissue adhesive; and cerium oxide nanoparticles (CNPs) or silver cerium oxide nanoparticles (AgCNPs) as taught herein having a predominant Ce³⁺ oxidation state and in a range of about 3-35 nanometers (nm) in size and mixed in an amount that is in a range of about 0.01 to 0.8 weight percent of a mixture having the tissue adhesive and the CNPs or AgCNPs wherein the CNPs or AgCNPs being produced using a method described herein.

In one embodiment, a therapeutic article of manufacture is provided that includes a body having fibers treated with a mixture including cerium oxide nanoparticles (CNPs) or silver cerium oxide nanoparticles (AgCNPs) having a predominant Ce³⁺ oxidation state and in a range of about 3-35 nanometers (nm) in size and one or more of a polymeric binder, a dispersant, and a stabilizer, the CNPs or AgCNPs being mixed in an amount that is in a range of about .01 to 0.1 weight percent of the mixture wherein the CNPs or AgCNPs being produced using a method described herein that uses at least one accelerant.

In one embodiment, a touch screen display is provided that includes a touch screen layer stack having a plurality of layers that includes a top surface layer; and a coating composition coating the top surface layer, the coating composition comprising cerium oxide nanoparticles (CNPs) or silver cerium oxide nanoparticles (AgCNPs) having a predominantly Ce³⁺ oxidation state and in a range of about 3-35 nm in size and in an amount that is in a range of about 1 weight percentage of a mixture having a binder and the CNPs or AgCNPs wherein the CNPs and AgCNPs being produced using a method described herein that uses at least one accelerant.

In one embodiment, a long-lasting and mechanically stable coating composition is provided that includes cerium oxide nanoparticles (CNPs) or silver cerium oxide nanoparticles (AgCNPs) ingredient as taught herein selected from a group consisting of predominantly Ce³⁺ oxidation state, wherein the CNPs and AgCNPs being produced using a method described herein that uses at least one accelerant; and a paint where the CNP or AgCNP ingredient has a weight percent loading less than about 1 weight % in a mixture with the paint that is a durable adhesive coating once cured.

In one embodiment, a wound healing composition is provided that includes an epithelial tissue healing agent; and cerium oxide nanoparticles (CNPs) or silver cerium oxide nanoparticles (AgCNPs) having a predominant Ce³⁺ oxidation state and in a range of about 3-35 nm in size and mixed in an amount that is in a range of about 0.01 to 0.1 weight percent of a mixture having the epithelial tissue healing agent and either CNPs or AgCNPs and wherein the CNPs and AgCNPs being produced using a method described herein that uses at least one accelerant.

In one embodiment, a dental resin composition is provided that includes a dental resin; and cerium oxide nanoparticles (CNPs) or silver cerium oxide nanoparticles (AgCNPs) having a predominantly Ce³⁺ oxidation state and in a range of about 3-35 nm in size and mixed in an amount that is in a range of about 0.01 to 0.8 weight percent of a mixture having the dental resin and the CNPs or AgCNPs, and the CNPs and AgCNPs effectuate release directed hydrogen peroxide (H₂O₂) in an oral cavity that is then used against bacteria in the oral cavity to prevent local acidification of a tooth on which a therapeutically effect amount of the mixture is applied and cured and wherein the CNPs or AgCNPs being produced using a method described herein that uses at least one accelerant.

In one embodiment, a process for manufacturing cerium oxide nanoparticles (CNPs) or silver cerium oxide nanoparticles (AgCNPs) is provided that includes using a process with at least one accelerant that speeds up the peroxy ligand conversion of CNPs and AgCNPs having a predominant Ce³⁺ oxidation state, the at least one accelerant accelerates evolution of cerium oxide nanoparticles and silver cerium oxide nanoparticles with no waste material byproduct.

In one embodiment, a process for manufacturing cerium oxide nanoparticles (CNPs) is provided that includes mixing in a single vessel cerium nitrate hexahydrate to form a solution; applying an accelerant to the solution; and forming from the solution the CNPs having a predominant Ce³⁺ oxidation state, the accelerant accelerates the formation of cerium oxide nanoparticles as a phase without any waste material byproduct.

In one embodiment, a process for manufacturing silver cerium oxide nanoparticles (AgCNPs) is provided that includes mixing in a single vessel cerium nitrate hexahydrate an silver nitrate to form a solution; applying an accelerant to the solution; and forming from the solution the AgCNPs having a predominant Ce³⁺ oxidation state, the accelerant accelerates the formation of cerium oxide nanoparticles as a phase without any waste material byproduct.

In one embodiment, the accelerant is selected from the group consisting of: applying low heat of 90°-115° F during an aging process during which peroxy ligand conversion takes place; and adding a food grade hydrogen peroxide or a wholly un-stabilized hydrogen peroxide.

In one embodiment, a process for manufacturing cerium oxide nanoparticles (CNPs) is provided that includes forming in a single vessel an initial solution between 250 gallons to 275 gallons that comprises cerium nitrate hexahydrate, wholly un-stabilized hydrogen peroxide; applying heat to the initial solution; and ageing the solution which forms the CNPs having a predominant Ce³⁺ oxidation state, and crystallization as a phase without any waste material byproduct within the vessel in less than 24 hours.

In one embodiment, a process for manufacturing silver cerium oxide nanoparticles (AgCNPs) is provided that includes forming in a single vessel an initial solution between 250 gallons to 275 gallons that comprises cerium nitrate hexahydrate, silver nitrate, wholly un-stabilized hydrogen peroxide; applying heat to the initial solution; and ageing the solution which forms the AgCNPs having a predominant Ce³⁺ oxidation state, and crystallization as a phase without any waste material byproduct within the vessel in less than 24 hours.

Thus, as disclosed above, an aspect includes a method for manufacturing cerium oxide nanoparticles (CNP as disclosed herein) and organic solvent mediated silver cerium oxide nanoparticles (AgCNP as disclosed herein) utilizing a miscible organic solvent, e.g. ethanol (EtOH) mixed in water with hydrogen peroxide (H₂O₂) to accelerate the aging process. The method includes ageing in a closed system un-aged cerium oxide nanoparticles in a mixture that includes EtOH, ≤ 5%water, and hydrogen peroxide (H₂O₂₎. The organic solvent speeds up peroxy ligand conversion to cerium oxide having a predominant oxidation state of Ce³⁺ allowing cerium oxide nanoparticles and organic solvent mediated silver cerium oxide nanoparticles to crystallize into organic solvent mediated cerium oxide nanoparticles and organic solvent mediated silver cerium oxide nanoparticles with stable ethanol mediated CNP and AgCNP.

An aspect includes a formulation comprising an aqueous solution including organic solvent mediated cerium oxide nanoparticles (CNP) having Ce³⁺ being the predominant species with a size range of about 3-35 nanometers (nm), wherein the aqueous solution including the ethanol, ≤ 5% water, and H₂O₂ with CNPs produced with a method that includes placing cerium nitrate hexahydrate (Ce(NO₃)₃·6H₂O) into the solution containing the EtOH, ≤ 5% water, and H₂O₂ at low heat to accelerate peroxy ligand conversion to form the organic solvent mediated CNP.

An aspect includes a formulation comprising an aqueous solution including organic solvent mediated silver cerium oxide nanoparticles (AgCNP) with Ce³⁺ being the predominant oxidation state of the cerium component and in a range of about 3-35 nanometers (nm) in size, wherein the aqueous solution including the AgCNP produced with a method that includes placing cerium nitrate hexahydrate (Ce(NO₃)₃.6H₂O) and silver nitrate (AgNO₃) ) into the solution containing the EtOH, ≤ 5% water, and H₂O₂ at low heat to accelerate peroxy ligand conversion solution, at low heat to accelerate peroxy ligand conversion to form AgCNP.

An aspect includes a therapeutic article of manufacture comprising a body having fibers treated with the formulation that includes a first composition comprising one or more of a polymeric binder, a dispersant, and a stabilizer and an aqueous solution that includes organic solvent mediated CNP. The ethanol mediated CNP is produced with a method that includes placing cerium nitrate hexahydrate into a water, ethanol, and hydrogen peroxide solution at low heat that speeds up peroxy ligand conversion of organic solvent mediated CNPs.

An aspect includes a therapeutic article of manufacture comprising a body having fibers treated with the formulation that includes a first composition comprising one or more of a polymeric binder, a dispersant, and a stabilizer and an aqueous solution that includes AgCNP. AgCNP is produced with a method that includes placing cerium nitrate hexahydrate (Ce(NO₃)₃.6H₂O) and silver nitrate (AgNO₃) into the solution containing the EtOH, ≤ 5% water, and H₂O₂ at low heat to accelerate peroxy ligand conversion solution, at low heat to accelerate peroxy ligand conversion to form AgCNP.

Another aspect includes a touch screen display comprising a touch screen layer stack having a plurality of layers that includes a top surface layer; and the formulation coating the top surface layer. The formulation comprising ethanol mediated CNPs having Ce³⁺ being the predominant species and in a range of about 3-35 nm in size and in an amount that is in a range of about 1 weight percentage of a mixture having a binder and the ethanol mediated CNP wherein the ethanol mediated CNP is produced using a method that includes placing cerium nitrate hexahydrate to a water, ethanol, and hydrogen peroxide solution, at low heat that speeds up peroxy ligand conversion to form ethanol mediated CNP.

Another aspect includes a touch screen display comprising a touch screen layer stack having a plurality of layers that includes a top surface layer; and the formulation coating the top surface layer. The formulation comprising AgCNP having a predominantly 3+ oxidation state for the cerium component cerium charge and in a range of about 3-35 nm in size and in an amount that is in a range of about 1 weight percentage of a mixture having a binder and the AgCNP wherein the AgCNP is produced using a method that includes placing cerium nitrate hexahydrate (Ce(NO₃)₃.6H₂O) and silver nitrate (AgNO₃) into the solution containing the EtOH, ≤ 5% water, and H₂O₂ at low heat to accelerate peroxy ligand conversion solution, at low heat to accelerate peroxy ligand conversion to form AgCNP.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

Embodiments are described herein with reference to the attached figures wherein like reference numerals are used throughout the figures to designate similar or equivalent elements. In some instances, figures are not drawn to scale and they are provided merely to illustrate aspects disclosed herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

1. A method for manufacturing cerium oxide nanoparticles (CNPs) comprising: ageing in a closed system un-aged cerium oxide nanoparticles in a solution that uses at least one accelerant, the at least one accelerant speeds up peroxy ligand conversion of cerium oxide nanoparticles (CNPs) and accelerates evolution to 1ppm or less of the limit of detection, cerium oxide nanoparticles (CNPs), wherein the at least one accelerant is selected from the group consisting of:
a) a solution consisting of ethanol mixed with between 1% and 5% water;
b) low heat of 90°-115°F applied to the closed system to heat the solution only after crash-out of the solution that is without an ingredient that incudes wholly un-stabilized hydrogen peroxide;
c) wholly un-stabilized hydrogen peroxide mixed in the solution prior to aging in the closed system;
d) low heat of 90°-115°F applied to the closed system to heat the solution that includes wholly un-stabilized hydrogen peroxide; and
e) a form factor (FF) ratio of a vessel of the closed system where the ageing takes place.

2. The method for manufacturing the CNPs of claim 1, wherein when the at least one accelerant comprises wholly un-stabilized hydrogen peroxide, the method further comprising:
mixing, in a single vessel, water, ethanol, cerium nitrate hexahydrate to form the solution; adding the wholly un-stabilized hydrogen peroxide to the solution in the single vessel; closing the vessel to form a closed system with the solution within the single vessel; and during the aging, forming from the solution the CNPs with Ce³⁺ being the predominant oxidation state of the cerium and in a range of about 3-35 nanometers (nm) in size, the accelerant accelerates evolution of all, to 1 ppm or less of the limit of detection, cerium oxide nanoparticles without any waste material byproduct.

3. The method of manufacturing the CNPs of claim 2, wherein the at least one accelerant further comprises the low heat of 90°-115°F applied to the closed system to heat the solution.

4. The method of manufacturing the CNPs of claim 3, wherein the ageing is completed in about 23 hours for 1X concentration of ingredients in a solution of about 250 gallons.

5. The method of manufacturing the CNPs of claim 1, wherein the at least one accelerant comprises the FF ratio, wherein the FF ratio is determined by a vessel having a height and an inner width (W1) and where a height of a volume (HV) of solution is less than the W1 so that the FF ratio is W1/HV > 1.

6. The method of manufacturing the CNPs of claim 1, wherein when the at least one accelerant comprises the low heat of 90°-115°F applied to the closed system to heat the solution only after crash-out of the solution, the wholly un-stabilized hydrogen peroxide is excluded from the accelerant.

7. A method for manufacturing silver cerium oxide nanoparticles (AgCNPs) comprising:
ageing in a closed system un-aged cerium oxide nanoparticles in a solution that uses at least one accelerant, the at least one accelerant speeds up peroxy ligand conversion of silver cerium oxide nanoparticles (AgCNPs) having a predominant Ce³⁺ oxidation state and accelerates evolution to 1ppm or less of the limit of detection silver cerium oxide nanoparticles (AgCNPs), wherein the at least one accelerant is selected from the group consisting of:
a) a solution consisting of ethanol mixed with between 1% and 5% water;
b) low heat of 90°-115°F applied to the closed system to heat the solution only after crash-out of the solution that is without an ingredient that incudes wholly un-stabilized hydrogen peroxide;
c) wholly un-stabilized hydrogen peroxide mixed in the solution prior to aging in the closed system;
d) low heat of 90°-115°F applied to the closed system to heat the solution that includes wholly un-stabilized hydrogen peroxide; and
e) a form factor (FF) ratio of a vessel of the closed system where the ageing takes place.

8. The method for manufacturing the AgCNPs of claim 7, wherein when the at least one accelerant comprises wholly un-stabilized hydrogen peroxide; the method further comprising:
mixing, in a single vessel, water, ethanol, cerium nitrate hexahydrate, and the silver nitrate to form the solution;
adding the wholly un-stabilized hydrogen peroxide to the solution in the single vessel; closing the vessel to form a closed system with the solution within the single vessel; and during the aging, forming from the solution the AgCNPs with Ce³⁺ being the predominant oxidation state of the cerium component and in a range of about 3-35 nanometers (nm) in size, the accelerant accelerates evolution of all, to 1 ppm or less of the limit of detection, ionized Ag crystallize onto cerium oxide nanoparticles as a non-ionized metallic silver phase without any waste material byproduct that is greater than 1 ppm of ionized silver.

9. The method for manufacturing the AgCNPs of claim 7, wherein when the accelerant comprises wholly un-stabilized hydrogen peroxide, the accelerant further comprising: mixing, in a single vessel, water, ethanol, cerium nitrate hexahydrate, and the silver nitrate to form the solution;
adding the wholly un-stabilized hydrogen peroxide to the solution in the single vessel; closing the vessel to form a closed system with the solution within the single vessel; and during the aging, forming from the solution the AgCNPs with Ce³⁺ being the predominant oxidation state of the cerium component and in a range of about 3-35 nanometers (nm) in size, the accelerant accelerates evolution of all, to 1 ppm or less of the limit of detection, ionized Ag crystallize onto cerium oxide nanoparticles as a non-ionized metallic silver phase without any waste material byproduct that is greater than 1 ppm of ionized silver.

10. The method of manufacturing the AgCNPs of claim 9, wherein the at least one accelerant further includes the low heat of 90°-115°F applied to the closed system to heat the solution.

11. The method of manufacturing the AgCNPs of claim 5, wherein the ageing is completed in about 23 hours for 1X concentration of ingredients in the solution of about 250 gallons.

12. The method of manufacturing the AgCNPs of claim 1, wherein the at least one accelerant comprises the FF ratio, wherein the FF ratio is determined by a vessel having a height and an inner width (W1) and where a height of a volume (HV) of solution is less than the W1 so that the FF ratio is W1/HV > 1.

13. The method of manufacturing the AgCNPs of claim 1, wherein when the at least one accelerant comprises the low heat of 90°-115°F applied to the closed system to heat the solution only after crash-out of the solution, the wholly un-stabilized hydrogen peroxide is excluded from the accelerant.
